(19) United States
(12) Patent Application Publication
(10) Pub. No.: US 2024/0337862 A1
(43) Pub. Date: Oct. 10, 2024

(54) DISPLAY APPARATUS

(71) Applicant: JVCKENWOOD Corporation, Yokohama-shi (JP)

(72) Inventor: Fumihiko ITO, Yokohama-shi (JP)

(21) Appl. No.: 18/748,160

(22) Filed: Jun. 20, 2024

Related U.S. Application Data
(63) Continuation of application No. PCT/JP2022/045533, filed on Dec. 9, 2022.

(30) Foreign Application Priority Data
Dec. 24, 2021 (JP) 2021-210869
Dec. 24, 2021 (JP) 2021-210870
Dec. 24, 2021 (JP) 2021-210871
Dec. 24, 2021 (JP) 2021-210872
Dec. 24, 2021 (JP) 2021-210873
Dec. 24, 2021 (JP) 2021-210874
Dec. 24, 2021 (JP) 2021-210875
Mar. 3, 2022 (JP) 2022-032461

(51) Int. Cl. G02B 30/00; B32B 7/023; B32B 17/06; B32B 17/10; B32B 27/08; B32B 27/18; G01J 1/44; G02B 26/10

(52) U.S. Cl. CPC G02B 30/00; B32B 7/023; B32B 17/06; B32B 17/10; B32B 27/08; B32B 27/18; G01J 1/44; B32B 2264/107; B32B 2307/412; B32B 2307/422; B32B 2307/7376; B32B 2457/20; G02B 26/101; G02B 2207/113

(57) ABSTRACT

A display apparatus includes: a display unit in which a plurality of fluorescent layers containing a phosphor are laminated in a direction from a first surface to a second surface; and an irradiation unit that radiates an excitation light incident on the display unit to excite the phosphor, changing a position of the excitation light in an in-plane direction. The display apparatus draws a stereoscopic image inside the display unit.

### CROSS REFERENCE TO RELATED APPLICATION

This application is a continuation of application No. PCT/JP2022/045533, filed on Dec. 9, 2022, and claims the benefit of priority from the prior Japanese Patent Applications No. 2021-210869, 2021-210870, 2021-210871, 2021-210872, 2021-210873, 2021-210874, 2021-210875, filed on Dec. 24, 2021 and the prior Japanese Patent Application No. 2022-032461, filed on Mar. 3, 2022, the entire content of which are incorporated herein by reference.

### BACKGROUND

### 1. Technical Field

The present disclosure relates to display apparatuses.

### 2. Description of the Related Art

A configuration of a stereoscopic image display apparatus in which quantum dot blocks are combined three-dimensionally and irradiated with ultraviolet light has been proposed (see, for example, Patent Literature 1). A method a stereoscopic image display apparatus whereby a substance having a secondary nonlinear optical effect is irradiated with an infrared ultrashort pulse laser to produce a second harmonic that is visible light has been proposed (see, for example, Patent Literature 2).
[Patent Literature 1] JP2015-165611
[Patent Literature 2] JP 2003-287711

The related art described above does not mention the control of the position of irradiation with ultraviolet light irradiating the quantum dot blocks. In order to display an intended stereoscopic image with high accuracy, it is preferable to appropriately control the irradiation position. In the related art described above, it is necessary to use a laser light source having a pulse width of several tens of picoseconds to several femtoseconds. Such an ultrashort pulse laser light source is very expensive, which can be an obstacle to the popularization of stereoscopic display apparatuses.

### SUMMARY

The present disclosure addresses the issue described above, and a purpose thereof is to provide a stereoscopic display technology.

A display apparatus according to an embodiment of the present disclosure includes: a display unit in which a plurality of fluorescent layers containing a phosphor are laminated in a direction from a first surface to a second surface; and an irradiation unit that radiates an excitation light incident on the display unit to excite the phosphor, changing a position of the excitation light in an in-plane direction.

Optional combinations of the aforementioned constituting elements, and mutual substitution of constituting elements and implementations of the present disclosure between methods, apparatuses, systems, etc. may also be practiced as additional modes of the present disclosure.

### BRIEF DESCRIPTION OF THE DRAWINGS

FIG. 1 is a diagram schematically showing the configuration of a display apparatus according to the first embodiment.

FIG. 2 is a graph schematically showing the relationship between the excitation light intensity and the light emission intensity of the phosphor.

FIG. 3 is a diagram schematically showing the relationship between the thickness of the fluorescent layer and the Rayleigh length of the excitation light.

FIG. 4 is a diagram schematically illustrating the configuration of a display apparatus according to the second embodiment.

FIG. 5 is a diagram schematically showing the configuration of a display apparatus according to the third embodiment.

FIG. 6 is a diagram schematically showing the arrangement of the first light collection position, the second light collection position, and the third light collection position.

FIG. 7 is a diagram schematically showing the configuration of a display unit according to the fourth embodiment.

FIG. 8 is a diagram schematically showing the relationship between the thickness of the fluorescent layer and the separation layer and the Rayleigh length of the excitation light.

FIG. 9 is a diagram schematically illustrating the arrangement of the first light collection position, the second light collection position, and the third light collection position in the fifth embodiment.

FIG. 10 is a diagram schematically showing the configuration of a display apparatus according to the sixth embodiment.

FIG. 11 is a diagram schematically showing the configuration of a display apparatus according to the seventh embodiment.

FIG. 12 is a diagram schematically showing the configuration of the display unit and the second irradiation unit according to the seventh embodiment.

FIG. 13 is a diagram schematically showing the configuration of a display apparatus according to the eighth embodiment.

FIG. 14 is a diagram schematically showing the configuration of a display apparatus according to the ninth embodiment.

FIG. 15 is a graph schematically showing an example of the light intensity distribution of the second excitation light.

FIG. 16 is a diagram schematically showing the configuration of a display apparatus according to the tenth embodiment.

FIG. 17 is a diagram schematically showing the configuration of a display apparatus according to the eleventh embodiment.

FIG. 18 is a diagram schematically showing the configuration of a display unit according to the twelfth embodiment.

FIG. 19 is a diagram schematically showing the configuration of a light sensor according to the twelfth embodiment.

FIG. 20 is a diagram schematically showing the configuration of a display apparatus according to the thirteenth embodiment.

FIG. 21 is a diagram schematically showing the configuration of a display apparatus according to the fourteenth embodiment.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration. To facilitate the understanding, the relative dimensions of the constituting elements in the drawings do not necessarily mirror the actual relative dimensions.

### First Embodiment

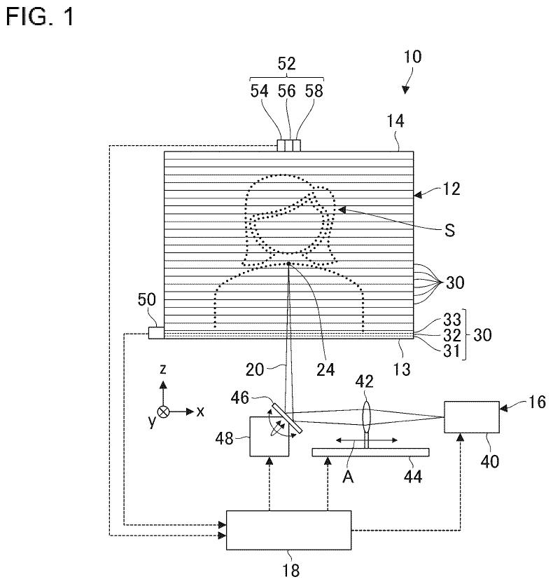

FIG. 1 is a diagram schematically showing the configuration of a display apparatus 10 according to the first embodiment. The display apparatus 10 includes a display unit 12, an irradiation unit 16, and a control unit 18. The display apparatus 10 is a so-called volume display and is configured to draw a stereoscopic image S inside the display unit 12.

The display unit 12 has a first surface 13 and a second surface 14 and includes a plurality of laminated bodies 30 laminated in the z direction from the first surface 13 to the second surface 14. Each of the plurality of laminated bodies 30 has a first fluorescent layer 31, a second fluorescent layer 32 and a third fluorescent layer 33. The display unit 12 has a structure in which a plurality of fluorescent layers are laminated sequentially (e.g., the first fluorescent layer 31, the second fluorescent layer 32, the third fluorescent layer 33, the first fluorescent layer 31, the second fluorescent layer 32, the third fluorescent layer 33, . . . ). For example, a plurality of second fluorescent layers 32 are disposed to alternate with a plurality of first fluorescent layers 31, and a plurality of third fluorescent layers 33 are disposed to alternate with a plurality of first fluorescent layers 31 and a plurality of second fluorescent layers 32.

The first fluorescent layer 31 is a fluorescent layer containing the first phosphor having an emission wavelength in the visible range and contains, for example, the first phosphor that emits red light (R). The second fluorescent layer 32 is a fluorescent layer containing the second phosphor having an emission wavelength in the visible range different from the first phosphor and contains, for example, the second phosphor that emits green light (G). The third fluorescent layer 33 is a fluorescent layer containing the third phosphor having a visible emission wavelength different from the first phosphor and the second phosphor and contains, for example, the third phosphor that emits blue light (B).

The material of the first phosphor, the second phosphor, and the third phosphor does not particularly matter. For example, a quantum dot phosphor can be used. By using a quantum dot phosphor, the first phosphor, the second phosphor, and the third phosphor may have a common excitation wavelength, and the first phosphor, the second phosphor, and the third phosphor may have different emission wavelengths (i.e., emission colors). By way of one example, nanocrystalline particles of cesium lead halide perovskite (CsPbX₃, X denotes a halogen, which could be Cl, Br, or I, or a mixture thereof) can be used as the phosphor. Ultraviolet light having an excitation wavelength of 300 nm-400 nm may be used for excitation to obtain RGB emission wavelengths.

The base material of the first fluorescent layer 31, the second fluorescent layer 32, and the third fluorescent layer 33 is made of a material transparent to visible light and is made of a resin material or a glass material. By mixing the phosphor in the transparent base material, each of the first fluorescent layer 31, the second fluorescent layer 32, and the third fluorescent layer 33 can be formed, and the display unit 12 can be formed by laminating the first fluorescent layer 31, the second fluorescent layer 32, and the third fluorescent layer 33 sequentially.

The display unit 12 is configured such that the entirety thereof has a solid column shape and is configured to have a cylindrical shape, a polygonal prism shape, or a cuboid shape. The display unit 12 is configured such that the surface of the display unit 12 has a mirror finish so that the interior of the display unit 12 can be seen from outside. The display unit 12 is formed so that the plurality of fluorescent layers 31, 32, and 33 are integrated so that the interface of the plurality of fluorescent layers 31, 32, and 33 is not visible or difficult to see.

The size of the display unit 12 is not particularly limited, but, for example, the size in the lamination direction (z direction) can be about 100 mm-1000 mm, and the size in the direction perpendicular to the lamination direction (x direction and y direction) can be about 100 mm-1000 mm. The thickness of each of the plurality of fluorescent layers 31, 32, and 33 can be, for example, about 10 μm-10 mm. By way of one example, the size of the display unit 12 in the x, y, and z directions can be 200 mm, and the thickness of each of the plurality of fluorescent layers 31, 32, and 33 can be 200 μm.

The irradiation unit 16 irradiates the display unit 12 with an excitation light 20 that excites the phosphor. The excitation light 20 is incident on the first surface 13 of the display unit 12 and irradiates the display unit 12 so that a light collection position 24 of the excitation light 20 changes over time inside the display unit 12. The irradiation unit 16 includes a light source 40, a light collection lens 42, a lens drive mechanism 44, a mirror 46, and a mirror drive mechanism 48.

The light source 40 produces the excitation light 20 for exciting the first, second, and third phosphors. The light source 40 produces an ultraviolet light having a center wavelength included in the range of 300 nm-400 nm as the excitation light 20. The type of the light source 40 does not matter, but, for example, a gallium nitride (GaN)-based semiconductor laser or a semiconductor LED (Light Emitting Diode) can be used as the light source 40.

The light collection lens 42 collects the excitation light 20 produced by the light source 40 toward the interior of the display unit 12. The lens drive mechanism 44 is configured to change the position of the light collection lens 42 in the optical axis direction A. The lens drive mechanism 44 changes the light collection position 24 of the excitation light 20 by changing the position of the light collection lens 42. The lens drive mechanism 44 makes the light collection position 24 of the excitation light 20 in the irradiation direction variable and makes the light collection position 24 in the direction intersecting the first surface 13 variable. It is noted that, instead of the light collection lens 42 and the lens drive mechanism 44, a variable focus lens may be used to make the light collection position 24 in the direction of intersecting the first surface 13 variable.

The mirror 46 reflects the excitation light 20 that has passed through the light collection lens 42 toward the display unit 12. The mirror 46 reflects the excitation light 20 so that the excitation light 20 is incident on the first surface 13. The mirror drive mechanism 48 is configured to change the orientation of the mirror 46. The mirror drive mechanism 48 is configured to make the orientation of the mirror 46 variable on two axes and changes the light collection position 24 of the excitation light 20 reflected by the mirror 46 in the direction along the first surface 13 (x direction and y direction). In the illustrated example, one mirror 46 is used, but the first mirror for scanning in the x direction and the second mirror for scanning in the y direction may be combined.

The light intensity of the excitation light 20 at the light collection position 24 is set to be equal or higher than the threshold value of the amplified spontaneous emission (ASE) of the phosphor contained in the display unit 12. For example, the intensity is set to be 1.3 times or more and 1.5 times or less higher than the threshold value (ASE threshold value) of the amplified spontaneous emission. Amplified spontaneous emission (ASE), also known as superluminescence, is a phenomenon in which an inverted distribution is created in a phosphor by an excitation light, and the light emission intensity of the phosphor is amplified. The threshold value of the amplified spontaneous emission (ASE threshold value) represents the minimum light intensity of the excitation light for producing ASE.

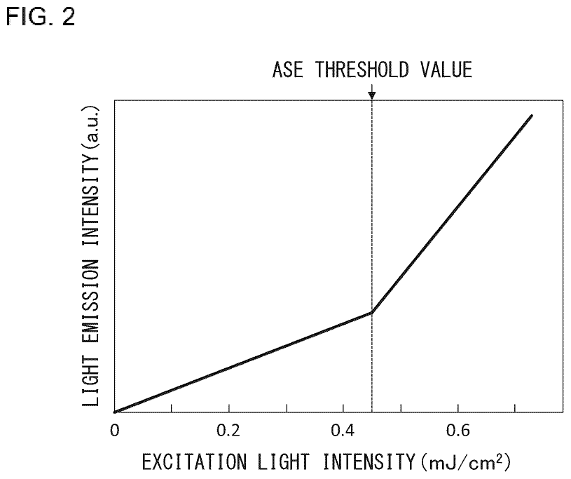

FIG. 2 is a graph schematically showing the relationship between the excitation light intensity and the light emission intensity of the phosphor and shows an example in which the phosphor is a nanocrystal of cesium halide lead perovskite. When the light intensity of the excitation light irradiating the phosphor is equal to or higher than the ASE threshold value (0.45 mJ/cm² in FIG. 2), the ratio (gradient) of the light emission intensity with respect to the excitation light intensity increases. By setting the excitation light intensity at the light collection position 24 to be equal to or higher than the ASE threshold value, the light emission intensity of the phosphor at the light collection position 24 can be further increased. By setting the excitation light intensity at a location different from the light collection position 24 to be lower than the ASE threshold, on the other hand, the light emission intensity of the phosphor at a location different from the light collection position 24 can be reduced, and the contrast ratio with respect to the light collection position 24 can be increased.

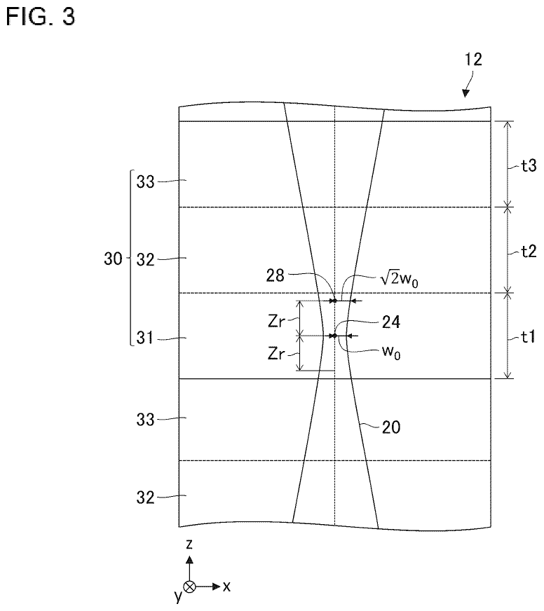

FIG. 3 is a diagram schematically showing the relationship between the thickness of the fluorescent layer and the Rayleigh length Zr of the excitation light 20. FIG. 3 shows a state in which the light collection position 24 of the excitation light 20 coincides with the first fluorescent layer 31. The excitation light 20 is configured such that it has the minimum beam radius Wo at the light collection position 24 and the beam radius expands in a direction away from the light collection position 24. The Rayleigh length Zr is the distance from the light collection position 24 to a position 28 where the beam radius of the excitation light 20 expands by √2 times and can be expressed as Zr=πw₀²/λ. A denotes the wavelength of the excitation light 20. The minimum beam radius w₀ depends on the optical system of the irradiation unit 16 and is, for example, about 1 μm-30 μm. In this case, the Rayleigh length Zr is about 10 μm-10 mm.

At the position 28 of the Rayleigh length Zr, the beam radius is √2×w₀ so that the beam intensity is half that of the light collection position 24. In the case the beam intensity at the light collection position 24 is 1.3 times-1.5 times the ASE threshold value, the beam intensity at the position 28 of the Rayleigh length Zr is 0.65 times-0.75 times the ASE threshold value so that ASE will not be produced. It is noted that the thickness t1 of the first fluorescent layer 31 twice or more larger than the Rayleigh length Zr of the excitation light 20 can prevent ASE from being produced in the fluorescent layer next to the first fluorescent layer 31 (the second fluorescent layer 32 and the third fluorescent layer 33) and can suppress color bleeding and degradation in drawing contrast.

FIG. 3 shows a case where the light collection position 24 of the excitation light 20 coincides with the first fluorescent layer 31, but the same applies to a case where the light collection position 24 of the excitation light 20 coincides with the second fluorescent layer 32 or the third fluorescent layer 33. The thickness t2 of the second fluorescent layer 32 is twice or more larger than the Rayleigh length Zr of the excitation light 20 that results when the light collection position 24 of the excitation light 20 coincides with the second fluorescent layer 32. The thickness t3 of the third fluorescent layer 33 is twice or more larger than the Rayleigh length Zr of the excitation light 20 that results when the light collection position 24 of the excitation light 20 coincides with the third fluorescent layer 33. The upper limit of the thickness t1, t2, and t3 of the first fluorescent layer 31, the second fluorescent layer 32, and the third fluorescent layer 33, respectively, does not particularly matter and is, but for example, 5 times or less, 4 times or less, or 3 times or less larger than the Rayleigh length Zr of the excitation light 20.

The thickness t1, t2, and t3 of the first fluorescent layer 31, the second fluorescent layer 32, and the third fluorescent layer 33, respectively, may differ according to the position in the z direction in the display unit 12 and may vary depending on, for example, the distance from the first surface 13. In the case the light collection position 24 of the excitation light 20 is changed according to the position of the one light collection lens 42 in the optical axis direction A, as shown in FIG. 1, the beam diameter w₀ at the light collection position 24 changes according to the position of the light collection lens 42. Specifically, as the light collection position 24 is distanced from the first surface 13 (that is, as the light collection position 24 approaches the second surface 14), the beam diameter Wo at the light collection position 24 increases. Since the Rayleigh length Zr is proportional to the square of the beam diameter Wo, the Rayleigh length Zr increases as the light collection position 24 is distanced from the first surface 13. The thickness t1, t2, and t3 of the plurality of first fluorescent layers 31, the plurality of second fluorescent layers 32, and the plurality of third fluorescent layers 33, respectively, may differ in accordance with a change in the Rayleigh length Zr dependent on the light collection position 24 in the z direction. That is, the thickness t1, t2, and t3 of the plurality of first fluorescent layers 31, the plurality of second fluorescent layers 32, and the plurality of third fluorescent layers 33, respectively, may be configured to increase in a direction away from the first surface 13.

Referring back to FIG. 1, the control unit 18 controls the operation of the irradiation unit 16. The control unit 18 is implemented in hardware such as devices and mechanical apparatus exemplified by a CPU and a memory of a computer, and in software such as a computer program. The functions provided by the control unit 18 can be realized by cooperation between hardware resources and software resources.

The control unit 18 controls the light collection position 24 of the excitation light 20 in three dimensions (x direction, y direction, and z direction) by controlling the operation of the lens drive mechanism 44 and the mirror drive mechanism 48. The control unit 18 causes the light collection position 24 of the excitation light 20 to perform three-dimensional scan inside the display unit 12 by, for example, periodically activating the lens drive mechanism 44 and the mirror drive mechanism 48.

The control unit 18 controls, for example, the on/off state of the light source 40 according to the light collection position 24 of the excitation light 20. The control unit 18 turns on the light source when the light collection position 24 of the excitation light 20 coincides with a location inside the display unit 12 where an image should be drawn. The control unit 18 turns off the light source when the light collection position 24 of the excitation light 20 coincides with a location inside the display unit 12 where an image should not be drawn.

The control unit 18 controls the on/off state of the light source 40 and the light emission intensity of the light source 40 based on, for example, stereoscopic contour image data produced from stereoscopic image data. The stereoscopic contour image data is data designating a three-dimensional position and a display color of the contour of the stereoscopic image S that should be drawn on the display unit 12. The control unit 18 controls the display color by controlling the light intensity of the excitation light 20 irradiating each of the first fluorescent layer 31, the second fluorescent layer 32, and the third fluorescent layer 33 adjacent to each other. Specifically, the emission color produced by mixing red, green, and blue at the position of light emission is controlled in full color, by controlling the amount of red light emitted in the first fluorescent layer 31, the amount of green light emitted in the second fluorescent layer 32, and the amount of blue light emitted in the third fluorescent layer 33.

The display apparatus 10 may further include an image sensor 50. The image sensor 50 is a two-dimensional photodetector such as a CCD sensor and a CMOS sensor and is provided to measure the spot size of the excitation light 20. The image sensor 50 is disposed adjacent to the display unit 12 at a position corresponding to the first surface 13. The image sensor 50 may be provided at a position different from the location shown so long as the excitation light 20 can be incident.

The control unit 18 activates the lens drive mechanism 44 and the mirror drive mechanism 48 so that the excitation light 20 is incident on the image sensor 50. The control unit 18 identifies the position of the light collection lens 42 at which the spot size of the excitation light 20 is the smallest, by measuring the size of the excitation light 20 with the image sensor 50, changing the position of the light collection lens 42. The position of the light collection lens 42 thus identified can be used as a reference for positioning in the z direction to align the light collection position 24 of the excitation light 20 with the first surface 13. The control unit 18 can calibrate the light collection position 24 of the excitation light 20 based on the measurement result of the image sensor 50.

The display apparatus 10 may further include a light sensor 52. The light sensor 52 is configured to measure the light intensity at each wavelength. The light sensor 52 is, for example, configured to measure the light intensity of the first emission color (for example, red) of the first phosphor, the light intensity of the second emission color (for example, green) of the second phosphor, and the light intensity of the third emission color (for example, blue) of the third phosphor. The light sensor 52 includes, for example, a first sensor 54 having a first filter that selectively transmits red light, a second sensor 56 having a second filter that selectively transmits green light, and a third sensor 58 having a third filter that selectively transmits blue light. The light sensor 52 is disposed on, for example, the second surface 14 of the display unit 12. The light sensor 52 may be provided at a position different from the location shown so long as it is possible to detect light emission produced in the display unit 12.

The control unit 18 acquires the light intensity of the first emission color, the second emission color, and the third emission color measured by the light sensor 52, activating the lens drive mechanism 44 to change the position of the light collection lens 42. Changing the light collection position 24 of the excitation light 20 changes which of the first fluorescent layer 31, the second fluorescent layer 32, and the third fluorescent layer 33 the excitation light 20 is strongly collected in and changes the light intensity of each of the first emission color, the second emission color, and the third emission color. For example, the position of the light collection lens 42 that results in the highest (or maximum) light intensity of the first emission color measured by the light sensor 52 can be used as a reference for positioning in the z direction to align the light collection position 24 of the excitation light 20 with the first fluorescent layer 31.

The control unit 18 can calibrate the light collection position 24 of the excitation light 20 based on the measurement result of the light sensor 52. The control unit 18 may calibrate the light collection position 24 before the stereoscopic image S starts to be drawn, based on the measurement result of the light sensor 52. The control unit 18 may, based on the measurement result of the light sensor 52, calibrate the light collection position 24 while the stereoscopic image S is being drawn or at a point of time while frames of the moving stereoscopic image S are being drawn. By calibrating the light collection position 24 of the excitation light 20 based on the measurement result of the light sensor 52, the positional accuracy of drawing the stereoscopic image S can be increased, and the accuracy of displaying the stereoscopic image S can be improved.

The operation of the display apparatus 10 will now be described. The control unit 18 acquires the stereoscopic contour image data and activates the irradiation unit 16 based on the stereoscopic contour image data. The control unit 18 controls the operation of the lens drive mechanism 44 and the mirror drive mechanism 48 to cause the light collection position 24 of the excitation light 20 to perform three-dimensional scan inside the display unit 12. The control unit 18 controls the output intensity of the light source 40 according to the light collection position 24 of the excitation light 20 to realize the display color designated by the stereoscopic contour image data for each drawing position. This makes it possible to draw the stereoscopic image S corresponding to the stereoscopic contour image data inside the display unit 12.

The control unit 18 may acquire the stereoscopic contour image data corresponding to frames of moving image data and draw different stereoscopic images S for the respective frames. The moving stereoscopic image S may be displayed in this way.

The control unit 18 may calibrate the light collection position 24 of the excitation light 20 based on the measurement result of the image sensor 50. The control unit 18 may calibrate the light collection position 24 before the stereoscopic image S starts to be drawn, based on the measurement result of the image sensor 50. The control unit 18 may, based on the measurement result of the image sensor 50, calibrate the light collection position 24 while the stereoscopic image S is being drawn or at a point of time while frames of the moving stereoscopic image S are being drawn.

According to this embodiment, light emission at a location different from the light collection position 24 can be suppressed by configuring the thickness t1, t2, and t3 of the first fluorescent layer 31, the second fluorescent layer 32, and the third fluorescent layer 33, respectively, included in each of the plurality of laminated bodies 30 to be twice or more larger than the Rayleigh length Zr. In this way, light emission in adjacent fluorescent layers having different emission colors can be suppressed, and color bleeding and contrast degradation can be suppressed. Further, strong light emission by ASE can be obtained at the light collection position 24, ASE is prevented from being produced in the adjacent fluorescent layers having different emission colors, and color bleeding and contrast degradation can be suppressed, by setting the light intensity at the light collection position 24 to be 1.3 times or more and 1.5 times or less higher than the ASE threshold value of the phosphor. As a result, the accuracy of displaying the stereoscopic image S can be improved.

### Second Embodiment

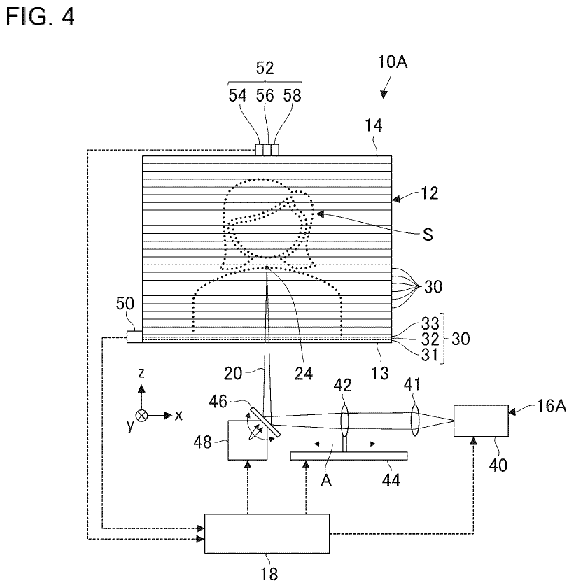

FIG. 4 is a diagram schematically illustrating the configuration of a display apparatus 10A according to the second embodiment. The second embodiment differs from the first embodiment described above in that an irradiation unit 16A further includes a collimating lens 41. The following description of the second embodiment highlights the difference from the first embodiment. A description of features common to those of the first embodiment is omitted as appropriate.

The display apparatus 10A includes a display unit 12, an irradiation unit 16A, and a control unit 18. The display apparatus 10B may or may not include an image sensor 50 and a light sensor 52. The display unit 12 and the control unit 18 are configured in the same manner as in the first embodiment.

The irradiation unit 16A includes a light source 40, a collimating lens 41, a light collection lens 42, a lens drive mechanism 44, a mirror 46, and a mirror drive mechanism 48. The light source 40, the light collection lens 42, the lens drive mechanism 44, the mirror 46, and the mirror drive mechanism 48 are configured in the same manner as in the first embodiment.

The collimating lens 41 parallelizes the excitation light 20 produced by the light source 40. The light collection lens 42 collects the excitation light 20 parallelized by the collimating lens 41 toward the interior of the display unit 12. The lens drive mechanism 44 changes the light collection position 24 of the excitation light 20 by changing the position of the light collection lens 42.

According to this embodiment, it is possible to suppress a change in the beam diameter w₀ and the Rayleigh length Zr at the light collection position 24 caused by changes in the light collection position 24 of the excitation light 20, by using the collimating lens 41. According to an example of this embodiment, it is possible to change the light collection position 24 while keeping the beam diameter w₀ and the Rayleigh length Zr at the light collection position 24 constant, by parallelizing the excitation light 20 using the collimating lens 41. As a result, it is possible to configure the thickness t1, t2, and t3 of the plurality of first fluorescent layers 31, the plurality of second fluorescent layers 32, and the plurality of third fluorescent layers 33, respectively, to be constant, while also configuring the thickness t1, t2, and t3 to be twice or more larger than the Rayleigh length Zr.

### Third Embodiment

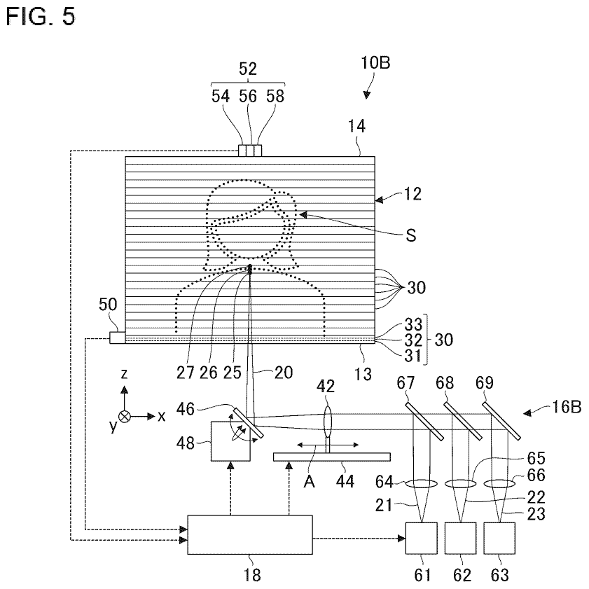

FIG. 5 is a diagram schematically showing the configuration of a display apparatus 10B according to the third embodiment. The third embodiment differs from the second embodiment described above in that the irradiation unit 16B includes a plurality of light sources 61, 62, and 63. The following description of the third embodiment highlights the difference from the second embodiment. A description of features common to those of the second embodiment is omitted as appropriate.

The display apparatus 10B includes a display unit 12, an irradiation unit 16B, and a control unit 18. The display apparatus 10B may or may not include an image sensor 50 and an light sensor 52. The display unit 12, the control unit 18, the image sensor 50, and the light sensor 52 are configured in the same manner as in the second embodiment.

The irradiation unit 16B includes a first light source 61, a second light source 62, a third light source 63, a first collimating lens 64, a second collimating lens 65, a third collimating lens 66, a first half mirror 67, a second half mirror 68, a third mirror 69, a light collection lens 42, a lens drive mechanism 44, a mirror 46, and a mirror drive mechanism 48. The light collection lens 42, the lens drive mechanism 44, the mirror 46, and the mirror drive mechanism 48 are configured in the same manner as in the second embodiment.

The first light source 61 produces a first excitation light 21 for exciting the first phosphor contained in the first fluorescent layer 31. The second light source 62 produces a second excitation light 22 for exciting the second phosphor contained in the second fluorescent layer 32. The third light source 63 produces a third excitation light 23 for exciting the third phosphor contained in the third fluorescent layer 33. The first excitation light 21, the second excitation light 22, and the third excitation light 23 are ultraviolet light having a center wavelength included in the range of 300 nm-400 nm. The center wavelengths of the first excitation light 21, the second excitation light 22, and the third excitation light 23 may be the same or different from each other. For example, the center wavelength of the first excitation light 21 may be 400 nm, the center wavelength of the second excitation light 22 may be 350 nm, and the center wavelength of the third excitation light 23 may be 300 nm. As in the light source 40 according to the first embodiment, a semiconductor laser or a semiconductor LED can be used as the first light source 61, the second light source 62, and the third light source 63.

The first collimating lens 64 parallelizes the first excitation light 21 produced by the first light source 61. The second collimating lens 65 parallelizes the second excitation light 22 produced by the second light source 62. The third collimating lens 66 parallelizes the third excitation light 23 produced by the third light source 63. The first half mirror 67 reflects the first excitation light 21 parallelized by the first collimating lens 64 toward the light collection lens 42. The second half mirror 68 reflects the second excitation light 22 parallelized by the second collimating lens 65 toward the light collection lens 42. The second excitation light 22 reflected by the second half mirror 68 passes through the first half mirror 67 and travels toward the light collection lens 42. The third mirror 69 reflects the third excitation light 23 parallelized by the third collimating lens 66 toward the light collection lens 42. The third excitation light 23 reflected by the third mirror 69 passes through the second half mirror 68 and the first half mirror 67 and travels toward the light collection lens 42. The first excitation light 21, the second excitation light 22, and the third excitation light 23 are superimposed on the same optical path by the first half mirror 67 and the second half mirror 68 and are then incident on the light collection lens 42.

The light collection lens 42 collects the excitation light 20, in which the first excitation light 21, the second excitation light 22, and the third excitation light 23 are superimposed on each other, toward the interior of the display unit 12. The mirror 46 reflects the excitation light 20 that has passed through the light collection lens 42 toward the display unit 12. The first excitation light 21 is collected at a first light collection position 25 by the light collection lens 42. The second excitation light 22 is collected at a second light collection position 26 by the light collection lens 42. The third excitation light 23 is collected at a third light collection position 27 by the light collection lens 42.

The first light collection position 25, the second light collection position 26, and the third light collection position 27 are configured such that the positions thereof in the irradiation direction (z direction) of the excitation light 20 are slightly different. For example, the first light collection position 25, the second light collection position 26 and the third light collection position 27 can be shifted from each other by fine-tuning the degree of parallelization of the first excitation light 21, the second excitation light 22 and the third excitation light 23 by the first collimating lens 64, the second collimating lens 65, and the third collimating lens 66.

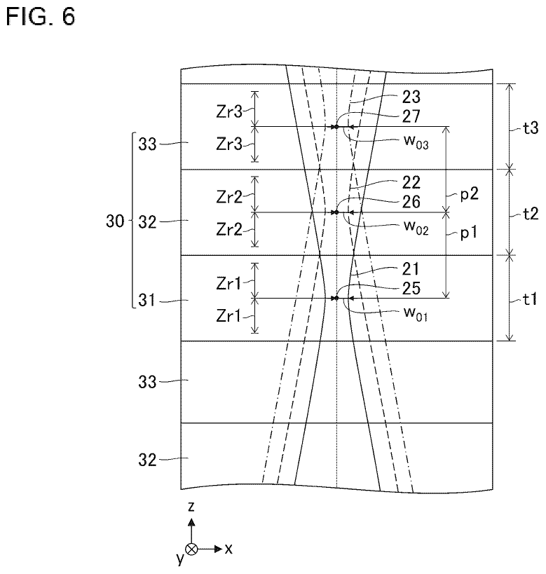

FIG. 6 is a diagram schematically showing the arrangement of the first light collection position 25, the second light collection position 26, and the third light collection position 27. FIG. 6 shows a case where the first light collection position 25 of the first excitation light 21 coincides with the first fluorescent layer 31. In the state of FIG. 6, the second light collection position 26 of the second excitation light 22 coincides with the second fluorescent layer 32, and the third light collection position 27 of the third excitation light 23 coincides with the third fluorescent layer 33. By setting the arrangement of the first light collection position 25, the second light collection position 26, and the third light collection position 27 as shown in FIG. 6, the first fluorescent layer 31, the second fluorescent layer 32, and the third fluorescent layer 33 included in one laminated body 30 can be excited at the same time. Further, by individually setting the light intensity of each of the first excitation light 21, the second excitation light 22, and the third excitation light 23, the amount of red light emitted in the first fluorescent layer 31, the amount of green light emitted in the second fluorescent layer 32, and the amount of blue light emitted in the third fluorescent layer 33 can be controlled to control the emission color produced by mixing red, green, and blue at the position of light emission in full color. In the example of FIG. 6, the distance between the first light collection position 25 and the second light collection position 26 is equal to the first pitch p1, which is the distance between the centers of the first fluorescent layer 31 and the second fluorescent layer 32. The first pitch p1 is equal to half (t1+t2)/2 the sum of the thickness t1 of the first fluorescent layer 31 and the thickness t2 of the second fluorescent layer 32. Further, the distance between the second light collection position 26 and the third light collection position 27 is equal to the second pitch p2, which is the distance between the centers of the second fluorescent layer 32 and the third fluorescent layer 33. The second pitch p2 is equal to half (t2+t3)/2 the sum of the thickness t2 of the second fluorescent layer 32 and the thickness t3 of the third fluorescent layer 33. The first pitch p1 may be equal to the thickness t1 of the first fluorescent layer 31 or the thickness t2 of the second fluorescent layer 32. The second pitch p2 may be equal to the thickness t2 of the second fluorescent layer 32 or the thickness t3 of the third fluorescent layer 33.

It is also preferable in this embodiment that the thickness of the fluorescent layer be twice or more larger than the Rayleigh length at the light collection position. The thickness t1 of the first fluorescent layer 31 is twice or more larger than the first Rayleigh length Zr1 at the first light collection position 25 of the first excitation light 21, and is 5 times or less, 4 times or less, or 3 times or less larger than the first Rayleigh length Zr1. The first Rayleigh length Zr1 is a position where the beam diameter of the first excitation light 21 is √2 times the minimum beam diameter w₀₁ at the first light collection position 25. The thickness t2 of the second fluorescent layer 32 is twice or more larger than the second Rayleigh length Zr2 at the second light collection position 26 of the second excitation light 22, and is 5 times or less, 4 times or less, or 3 times or less larger than the second Rayleigh length Zr2. The second Rayleigh length Zr2 is a position where the beam diameter of the second excitation light 22 is √2 times the minimum beam diameter w₀₂ at the second light collection position 26. The thickness t3 of the third fluorescent layer 33 is twice or more larger than the third Rayleigh length Zr3 at the third light collection position 27 of the third excitation light 23, and is 5 times or less, 4 times or less, or 3 times or less larger than the third Rayleigh length Zr3. The third Rayleigh length Zr3 is a position where the beam diameter of the third excitation light 23 is √2 times the minimum beam diameter w₀₃ at the third light collection position 27.

It is also preferable in this embodiment that the light intensity of the excitation light at the light collection position is 1.3 times or more and 1.5 times or less higher than the ASE threshold value of the phosphor. The light intensity of the first excitation light 21 at the first light collection position 25 is 1.3 times or more and 1.5 times or less higher than the ASE threshold value of the first phosphor included in the first fluorescent layer 31. Setting the light intensity of the first excitation light 21 in this way produces ASE in the first fluorescent layer 31 due to the first excitation light 21 and prevents ASE from being produced in the second fluorescent layer 32 or the third fluorescent layer 33 due to the first excitation light 21. Similarly, the light intensity of the second excitation light 22 at the second light collection position 26 is 1.3 times or more and 1.5 times or less higher than the ASE threshold value of the second phosphor included in the second fluorescent layer 32. Setting the light intensity of the second excitation light 22 in this way produces ASE in the second fluorescent layer 32 due to the second excitation light 22 and prevents ASE from being produced in the first fluorescent layer 31 or the third fluorescent layer 33 due to the second excitation light 22. Further, the light intensity of the third excitation light 23 at the third light collection position 27 is 1.3 times or more and 1.5 times or less higher than the ASE threshold value of the third phosphor included in the third fluorescent layer 33. Setting the light intensity of the third excitation light 23 in this way produces ASE in the third fluorescent layer 33 due to the third excitation light 23 and prevents ASE from being produced in the first fluorescent layer 31 or the second fluorescent layer 32 due to the third excitation light 23. As a result, color bleeding and degradation in drawing contrast can be suppressed, and the accuracy of displaying the stereoscopic image S can be improved.

### Fourth Embodiment

The fourth embodiment differs from the first embodiment described above in that a separation layer not containing a phosphor is provided between two fluorescent layers having different emission colors. According to the fourth embodiment, color bleeding and degradation in drawing contrast can be more suitably suppressed by providing a separation layer. According to the fourth embodiment, the pitch of two fluorescent layers having different emission colors can be reduced by providing a separation layer so that a higher definition stereoscopic image S can be drawn. The following description of the fourth embodiment highlights the difference from the first embodiment. A description of features common to those of the first embodiment is omitted as appropriate.

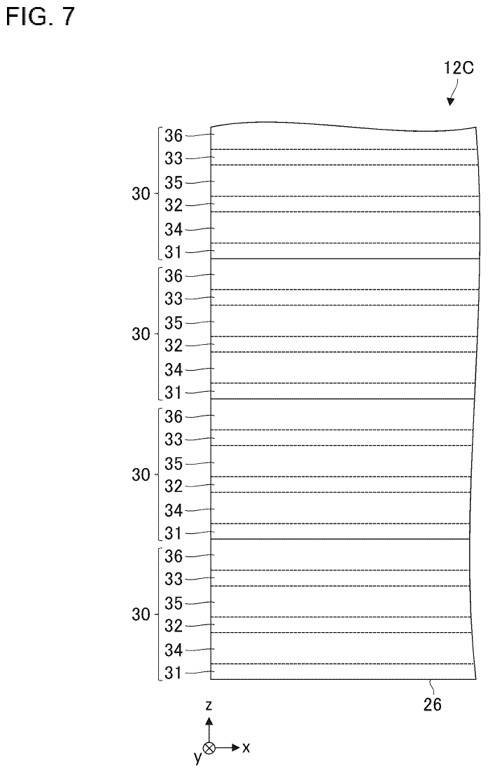

FIG. 7 is a diagram schematically showing the configuration of a display unit 12C according to the fourth embodiment. The display unit 12C includes a plurality of laminated bodies 30 laminated in the z direction. Each of the plurality of laminated bodies 30 includes a first fluorescent layer 31, a first separation layer 34, a second fluorescent layer 32, a second separation layer 35, a third fluorescent layer 33 and a third separation layer 36, which are laminated sequentially in the z direction. The first fluorescent layer 31, the second fluorescent layer 32, and the third fluorescent layer 33 are configured in the same manner as in the first embodiment.

The first separation layer 34, the second separation layer 35, and the third separation layer 36 are layers that do not contain a phosphor and are made of a resin material or a glass material that is transparent to visible light. The first separation layer 34, the second separation layer 35, and the third separation layer 36 are preferably made of the same material as the base material of the first fluorescent layer 31, the second fluorescent layer 32, and the third fluorescent layer 33. The first separation layer 34, the second separation layer 35, and the third separation layer 36 are integrated so that the interface with the first fluorescent layer 31, the second fluorescent layer 32, or the third fluorescent layer 33 is not visible or difficult to see.

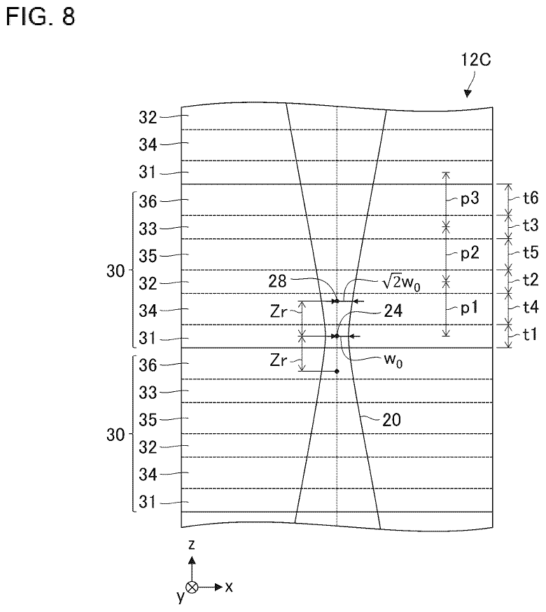

FIG. 8 is a diagram schematically showing the relationship between the thickness of the fluorescent layer and the separation layer and the Rayleigh length Zr of the excitation light 20. Like FIG. 3, FIG. 8 shows a state in which the light collection position 24 of the excitation light 20 coincides with the first fluorescent layer 31. Referring to FIG. 8, ASE is prevented from being produced in the second fluorescent layer 32 provided that the second fluorescent layer 32 is distanced from the position 28 defined by the Rayleigh length Zr from the light collection position 24. Therefore, the sum of half of the thickness t1 of the first fluorescent layer 31 and the thickness t4 of the first separation layer 34 is preferably equal to or larger than the Rayleigh length Zr (i.e., t1/2+t4≥Zr). Similarly, the sum of half of the thickness t2 of the second fluorescent layer 32 and the thickness t5 of the second separation layer 35 is preferably equal to or larger than the Rayleigh length Zr (i.e., t2/2+t5≥Zr), and the sum of half of the thickness t3 of the third fluorescent layer 33 and the thickness t6 of the third separation layer 36 is preferably equal to or larger than the Rayleigh length Zr (i.e., t3/2+t6≥Zr).

In this embodiment, the first pitch p1, which is the distance between the centers of the first fluorescent layer 31 and the second fluorescent layer 32, can be reduced compared to that of the first embodiment by providing the first separation layer 34. In the first embodiment of FIG. 3, the thickness t1 and t2 of the first fluorescent layer 31 and the second fluorescent layer 32 is required to be twice or more larger than the Rayleigh length Zr so that the first pitch p1 of the first fluorescent layer 31 and the second fluorescent layer 32 is also twice or more larger than the Rayleigh length Zr. In the fourth embodiment of FIG. 8, on the other hand, the first pitch p1 of the first fluorescent layer 31 and the second fluorescent layer 32 can be set to be larger than the Rayleigh length Zr and smaller than twice the Rayleigh length Zr. Given, for example, that the thickness t1 and t2 of the first fluorescent layer 31 and the second fluorescent layer 32 is configured to be the Rayleigh length Zr (t1=t2=Zr), and the thickness t4 of the first separation layer 34 is configured to be half the Rayleigh length Zr (t4=Zr/2), it is possible to set the first pitch p1 of the first fluorescent layer 31 and the second fluorescent layer 32 to be 1.5 times the Rayleigh length, while also satisfying the condition (t1/2+t4≥Zr) for preventing ASE from being produced in the second fluorescent layer 32. Similarly, it is possible to set the second pitch p2, which is the distance between the centers of the second fluorescent layer 32 and the third fluorescent layer 33, to be larger than the Rayleigh length Zr and smaller than twice the Rayleigh length Zr, by providing the second separation layer 35. Further, it is possible to set the third pitch p3, which is the distance between the centers of the third fluorescent layer 33 and the first fluorescent layer 31, to be larger than the Rayleigh length Zr and smaller than twice the Rayleigh length Zr, by providing the third separation layer 36.

In this embodiment, the first pitch p1 may be equal to or larger than the sum of half of the thickness of the first fluorescent layer 31 (or the second fluorescent layer 32) and the Rayleigh length Zr (i.e., p1≥t1/2+Zr, or p1≥t2/2+Zr). Similarly, the second pitch p2 may be equal to or larger than the sum of half of the thickness of the second fluorescent layer 32 (or the third fluorescent layer 33) and the Rayleigh length Zr (i.e., p2≥t2/2+Zr, or p2≥t3/2+Zr). Further, the third pitch p3 may be equal to or larger than the sum of half of the thickness of the third fluorescent layer 33 (or the first fluorescent layer 31) and the Rayleigh length Zr (i.e., p3≥t3/2+Zr, or p3≥t1/2+Zr).

In the fourth embodiment, the thickness t1, t2, t3 of the plurality of first fluorescent layers 31, the plurality of second fluorescent layers 32, and the plurality of third fluorescent layers 33, respectively, may differ in accordance with a change in the Rayleigh length Zr dependent on the light collection position 24 in the z direction. That is, the thickness t1, t2, and t3 of the plurality of first fluorescent layers 31, the plurality of second fluorescent layers 32, and the plurality of third fluorescent layers 33, respectively, may be configured to increase in a direction away from the first surface 13. Similarly, the thickness t4, t5, and t6 of the plurality of first separation layers 34, the plurality of second separation layers 35, and the plurality of third separation layers 36, respectively, may be configured to increase in a direction away from the first surface 13.

In a variation of the fourth embodiment, the irradiation unit 16A according to the second embodiment may be used. In this case, the thickness t1, t2, t3 of the plurality of first fluorescent layers 31, the plurality of second fluorescent layers 32, and the plurality of third fluorescent layers 33 may be constant, and the thickness t4, t5, t6 of the plurality of first separation layers 34, the plurality of second separation layers 35, and the plurality of third separation layers 36 may be constant.

### Fifth Embodiment

The display apparatus according to the fifth embodiment includes the display unit 12C according to the fourth embodiment, and the irradiation unit 16B and the control unit 18 according to the third embodiment. The following description of the fifth embodiment highlights the difference from the third embodiment and the fourth embodiment. A description of features common to those of the third embodiment and the fourth embodiment is omitted as appropriate.

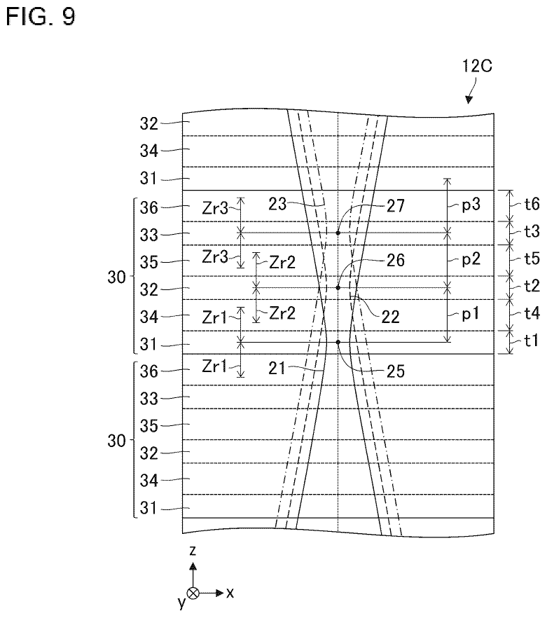

FIG. 9 is a diagram schematically illustrating the arrangement of the first light collection position 25, the second light collection position 26, and the third light collection position 27 in the fifth embodiment. As in the fourth embodiment, the display unit 12C according to the fifth embodiment is configured such that the laminated body 30 includes the first fluorescent layer 31, the second fluorescent layer 32, the third fluorescent layer 33, the first separation layer 34, the second separation layer 35, and the third separation layer 36. FIG. 9 shows a case where the first light collection position 25 of the first excitation light 21 coincides with the first fluorescent layer 31. In the state of FIG. 9, the second light collection position 26 of the second excitation light 22 coincides with the second fluorescent layer 32, and the third light collection position 27 of the third excitation light 23 coincides with the third fluorescent layer 33.

In the example of FIG. 9, the distance between the first light collection position 25 and the second light collection position 26 is equal to the first pitch p1, which is the distance between the centers of the first fluorescent layer 31 and the second fluorescent layer 32. The first pitch p1 is equal to the sum (t1/2+t4+t2/2) of half of the thickness t1 of the first fluorescent layer 31, the thickness t4 of the first separation layer 34, and half of the thickness t2 of the second fluorescent layer 32. The first pitch p1 can be, for example, set to be larger than the first Rayleigh length Zr1 of the first excitation light 21 and smaller than twice the first Rayleigh length Zr1, or larger than the second Rayleigh length Zr2 of the second excitation light 22 and smaller than twice the second Rayleigh length Zr2. In the example of FIG. 9, the range of the first Rayleigh length Zr1 at the first light collection position 25 and the range of the second Rayleigh length Zr2 at the second light collection position 26 can be superimposed in the first separation layer 34. Therefore, the first pitch p1 can be configured to be smaller than in the case of FIG. 6. As a result, the first fluorescent layer 31 and the second fluorescent layer 32 having different emission colors can be brought closer together so that a higher definition stereoscopic image S can be drawn. The first pitch p1 may be equal to or larger than the sum of half of the thickness of the second fluorescent layer 32 (or the first fluorescent layer 31) and the first Rayleigh length Zr1 (or the second Rayleigh length Zr2) (i.e., p1≥t2/2+Zr1, or p1≥t1/2+Zr1).

The distance between the second light collection position 26 and the third light collection position 27 is equal to the second pitch p2, which is the distance between the centers of the second fluorescent layer 32 and the third fluorescent layer 33. The second pitch p2 is equal to the sum (t2/2+t5+t3/2) of half of the thickness t2 of the second fluorescent layer 32, the thickness t5 of the second separation layer 35, and half of the thickness t3 of the third fluorescent layer 33. The second pitch p2 can be, for example, set to be larger than the second Rayleigh length Zr2 of the second excitation light 22 and smaller than twice the second Rayleigh length Zr2, or larger than the third Rayleigh length Zr3 of the third excitation light 23 and smaller than twice the third Rayleigh length Zr3. The second pitch p2 may be equal to or larger than the sum of half of the thickness of the third fluorescent layer 33 (or the second fluorescent layer 32) and the second Rayleigh length Zr2 (or the third Rayleigh length Zr3) (i.e., p2≥t3/2+Zr2, or p2≥t2/2+Zr3).

The third pitch p3, which is the distance between the centers of the third fluorescent layer 33 and the first fluorescent layer 31, is equal to the sum (t3/2+t6+t1/2) of half of the thickness t3 of the third fluorescent layer 33, the thickness t6 of the third separation layer 36, and half of the thickness t1 of the first fluorescent layer 31. The third pitch p3 can be, for example, set to be larger than the third Rayleigh length Zr3 of the third excitation light 23 and smaller than twice the third Rayleigh length Zr3, or larger than the first Rayleigh length Zr1 of the first excitation light 21 and smaller than twice the first Rayleigh length Zr1. The third pitch p3 may be equal to or larger than the sum of half of the thickness of the first fluorescent layer 31 (or the third fluorescent layer 33) and the third Rayleigh length Zr3 (or the first Rayleigh length Zr1) (i.e., p3≥t1/2+Zr3, or p3≥t3/2+Zr1).

It is noted that the first pitch P1, the second pitch P2, and the third pitch P3 may be equal to the sum (t1+t4) of the thickness of the first fluorescent layer 31 and the first separation layer 34, the sum (t2+t5) of the thickness of the second fluorescent layer 32 and the second separation layer 35, or the sum (t3+t6) of the thickness of the third fluorescent layer 33 and the third separation layer 36.

### Sixth Embodiment

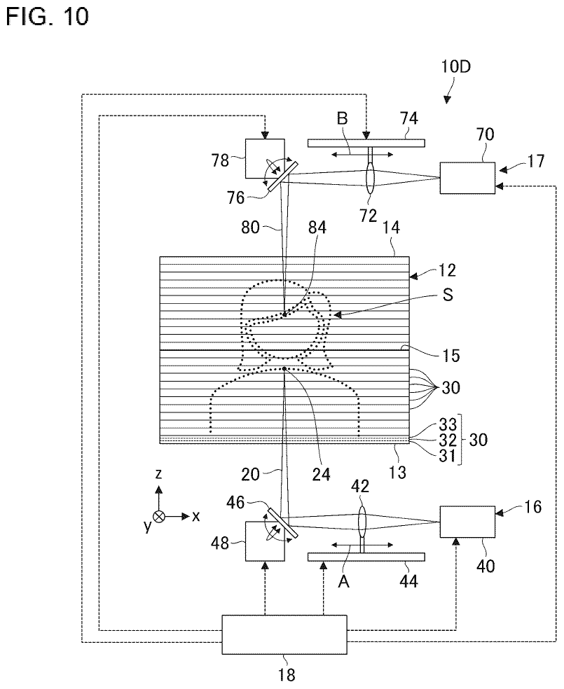

FIG. 10 is a diagram schematically showing the configuration of a display apparatus 10D according to the sixth embodiment. The sixth embodiment differs from the first embodiment described above in that a second irradiation unit 17 that radiates an excitation light 80 toward the second surface 14 of the display unit 12 is further provided in addition to the first irradiation unit 16 that radiates the excitation light 20 toward the first surface 13 of the display unit 12. The following description of the sixth embodiment highlights the difference from the first embodiment. A description of features common to those of the first embodiment is omitted as appropriate.

The display apparatus 10D includes a display unit 12, a first irradiation unit 16, a second irradiation unit 17, and a control unit 18. The first irradiation unit 16 radiates the excitation light 20 so that the light collection position 24 of the excitation light 20 is variable in the range from the first surface 13 to an intermediate surface 15 of the display unit 12. The second irradiation unit 17 radiates the excitation light 80 so that a light collection position 84 of the excitation light 80 is variable in the range from the second surface 14 to the intermediate surface 15 of the display unit 12. The intermediate surface 15 is set at an arbitrary position between the first surface 13 and the second surface 14 and is, for example, set at the midpoint between the first surface 13 and the second surface 14.

The second irradiation unit 17 is configured in the same manner as in the first irradiation unit 16. The second irradiation unit 17 includes a light source 70, a light collection lens 72, a lens drive mechanism 74, a mirror 76, and a mirror drive mechanism 78. Like the light source 40, the light source 70 produces the excitation light 80 for exciting the first phosphor, the second phosphor, and the third phosphor. The light collection lens 72 collects the excitation light 80 produced by the light source 70 toward the interior of the display unit 12. The lens drive mechanism 74 changes the position of the light collection lens 72 in the optical axis direction B and changes the light collection position 84 of the excitation light 80. The mirror 76 reflects the excitation light 80 so that the excitation light 80 that has passed through the light collection lens 72 is incident on the second surface 14. The mirror drive mechanism 78 changes the orientation of the mirror 76 and changes the light collection position 84 of the excitation light 80 reflected by the mirror 76 in the direction along the second surface 14 (x direction and y direction).

The control unit 18 controls the operation of the first irradiation unit 16 and the second irradiation unit 17. The control unit 18 acquires the stereoscopic contour image data and activates the first irradiation unit 16 based on a portion of the stereoscopic contour image data for drawing the range from the first surface 13 to the intermediate surface 15. The control unit 18 activates the second irradiation unit 17 based on a portion of the stereoscopic contour image data for drawing the range from the intermediate surface 15 to the second surface 14. According to this embodiment, the stereoscopic image S can be drawn using the excitation light 20 and 80 incident on the first surface 13 and the second surface 14, respectively, so that drawing can be speeded up compared to the case of using only the excitation light 20.

The thickness t1, t2, and t3 of the first fluorescent layer 31, the second fluorescent layer 32, and the third fluorescent layer 33, respectively, included in the display unit 12 may differ according to the position in the z direction. The thickness t1, t2, and t3 of the plurality of first fluorescent layers 31, the plurality of second fluorescent layers 32, and the plurality of third fluorescent layers 33, respectively, may be configured to increase in a direction from the first surface 13 toward the intermediate surface 15. The thickness t1, t2, and t3 of the plurality of first fluorescent layers 31, the plurality of second fluorescent layers 32, and the plurality of third fluorescent layers 33, respectively, may be configured to increase in a direction from the second surface 14 toward the intermediate surface 15.

In a variation of the sixth embodiment, the irradiation unit 16A according to the second embodiment may be used as the first irradiation unit 16 and the second irradiation unit 17. In this case, the thickness t1, t2, t3 of the plurality of first fluorescent layers 31, the plurality of second fluorescent layers 32, and the plurality of third fluorescent layers 33 may be constant. Alternatively, the irradiation unit 16B according to the third embodiment may be used as the first irradiation unit 16 and the second irradiation unit 17. Further, the display unit 12C according to the fourth embodiment may be used instead of the display unit 12.

### Seventh Embodiment

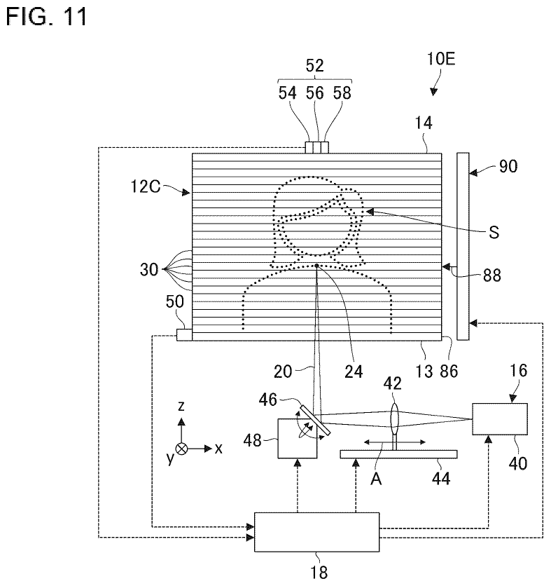

FIG. 11 is a diagram schematically showing the configuration of a display apparatus 10E according to the seventh embodiment. In the seventh embodiment, the display unit 12C like that of the fourth and fifth embodiments including the same separation layer is provided. The seventh embodiment differs from the embodiments described above in that, in addition to the first irradiation unit 16 that radiates the first excitation light 20 toward the first surface 13 of the display unit 12C, the second irradiation unit 90 that radiates the second excitation light 88 toward a side surface 86 of the display unit 12C is further provided. The following description of the seventh embodiment highlights the difference from the embodiments described above. A description of features common to those of the embodiments described above is omitted as appropriate.

The display apparatus 10E includes a display unit 12C, a first irradiation unit 16, a second irradiation unit 90, and a control unit 18. The display apparatus 10E may or may not include an image sensor 50 and a light sensor 52. The first irradiation unit 16 is configured in the same manner as the irradiation unit 16 according to the first embodiment. The control unit 18, the image sensor 50, and the light sensor 52 are configured in the same manner as in the first embodiment.

The display unit 12C has the side surface 86. The side surface 86 is provided between the first surface 13 and the second surface 14 and extends in the lamination direction of the display unit 12C. In the case the display unit 12C is a cuboid, the display unit 12C has four rectangular side surfaces 86. In the case the display unit 12C is a cylinder, the display unit 12C has a side surface 86 that is a cylindrical surface.

The second irradiation unit 90 is provided to the side of the display unit 12C and radiates the second excitation light 88 toward the side surface 86 of the display unit 12C. The second irradiation unit 90 radiates the second excitation light 88 toward one fluorescent layer included in one of the plurality of laminated bodies 30. The second excitation light 88 is incident on the fluorescent layer to be irradiated in the in-plane direction and excites the phosphor contained in the fluorescent layer to be irradiated. The second irradiation unit 90 irradiates the entirety of the fluorescent layer to be irradiated with the second excitation light 88 in the in-plane direction.

The second irradiation unit 90 is configured to switch the fluorescent layer to be irradiated by changing the position of the second excitation light 88 in the lamination direction. The second irradiation unit 90 selectively radiates the second excitation light 88 toward one fluorescent layer included in one of the plurality of laminated bodies 30. The second irradiation unit 90 radiates the second excitation light 88 toward one fluorescent layer corresponding to the light collection position 24 of the first excitation light 20.

At the light collection position 24 of the first excitation light 20, the phosphor emits light by being irradiated with both the first excitation light 20 and the second excitation light 88. At the light collection position 24 of the first excitation light 20, the light intensity of each of the first excitation light 20 and the second excitation light 88 is lower than the threshold value of the amplified spontaneous emission of the phosphor (i.e., lower than the ASE threshold value). At the light collection position 24 of the first excitation light 20, the total value of the light intensity of the first excitation light 20 and the second excitation light 88 is equal to or higher than the threshold value of the amplified spontaneous emission of the phosphor (i.e., equal to or higher than the ASE threshold value). This makes it possible to obtain strong light emission by ASE at the light collection position 24, to prevent ASE from being produced in the adjacent fluorescent layers having different emission colors, and to suppress color bleeding and contrast degradation. As a result, the accuracy of displaying the stereoscopic image S can be improved.

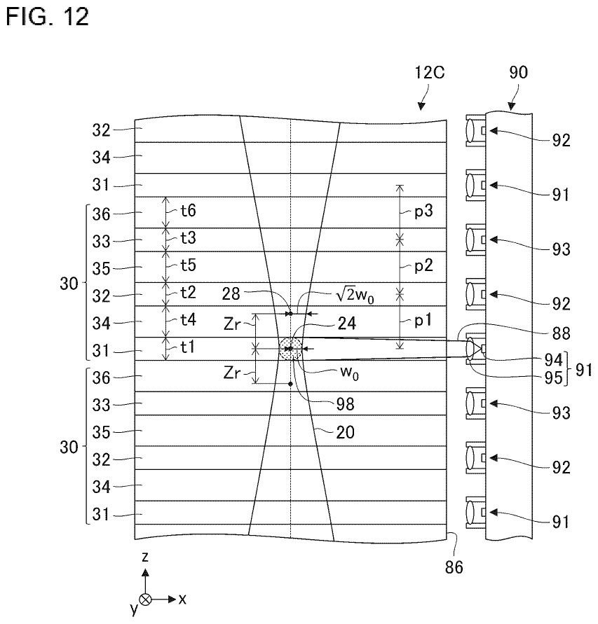

FIG. 12 is a diagram schematically showing the configuration of the display unit 12C and the second irradiation unit 90 according to the seventh embodiment. The display unit 12C includes a plurality of laminated bodies 30 laminated in the z direction. Each of the plurality of laminated bodies 30 includes a first fluorescent layer 31, a first separation layer 34, a second fluorescent layer 32, a second separation layer 35, a third fluorescent layer 33 and a third separation layer 36, which are laminated sequentially in the z direction. The first fluorescent layer 31, the second fluorescent layer 32, and the third fluorescent layer 33 are configured in the same manner as in the first embodiment.

The first separation layer 34, the second separation layer 35, and the third separation layer 36 are layers that do not contain a phosphor and are made of a resin material or a glass material that is transparent to visible light. The refractive index of the first separation layer 34, the second separation layer 35, and the third separation layer 36 (collectively referred to as the separation layers) is lower than the refractive index of the first fluorescent layer 31, the second fluorescent layer 32, and the third fluorescent layer 33 (collectively referred to as the fluorescent layers). The refractive index of the separation layer is slightly lower than that of the fluorescent layer. The difference between the refractive index of the separation layer and the refractive index of the fluorescent layer is, for example, 0.01 or larger and 0.05 or smaller and, preferably 0.02 or larger and 0.04 or smaller.

The second irradiation unit 90 includes a plurality of light source units 91, 92, and 93. The second irradiation unit 90 includes a plurality of first light sources 91, a plurality of second light sources 92, and a plurality of third light sources 93. Each of the plurality of first light sources 91 radiates the second excitation light 88 toward the corresponding first fluorescent layer 31 in the in-plane direction of the first fluorescent layer 31. Each of the plurality of second light sources 92 radiates the second excitation light toward the corresponding second fluorescent layer 32 in the in-plane direction of the second fluorescent layer 32. Each of the plurality of third light sources 93 irradiates the second excitation light toward the corresponding third fluorescent layer 33 in the in-plane direction of the third fluorescent layer 33.

The first light source 91 includes a light emitting element 94 that outputs the second excitation light 88 and a collimating lens 95 that collimates the second excitation light 88 output from the light emitting element 94. The light emitting element 94 is a semiconductor laser or a semiconductor LED. The collimating lens 95 ensures that the light distribution angle of the second excitation light 88 incident on the first fluorescent layer 31 is equal to or smaller than a predetermined value. The light distribution angle of the second excitation light 88 collimated by the collimating lens 95 is 30 degrees or smaller and, preferably 20 degrees or smaller, or 10 degrees or smaller. The second light source 92 and the third light source 93 are configured in the same manner as the first light source 91.

The first light source 91 selectively radiates the second excitation light 88 toward the corresponding first fluorescent layer 31. The second excitation light 88 incident on the first fluorescent layer 31 travels in the in-plane direction inside the first fluorescent layer 31 while being reflecting at the interface of the first fluorescent layer 31. Since the refractive index of the first fluorescent layer 31 is higher than the refractive index of the first separation layer 34 and the third separation layer 36 adjacent to the first fluorescent layer 31, the second excitation light 88 can be totally reflected at the interface of the first fluorescent layer 31. In the case the refractive index difference between the first fluorescent layer 31 and the first separation layer 34/the third separation layer 36 adjacent to the first fluorescent layer 31 is 0.01 or larger and 0.05 or smaller, the critical angle at the interface of the first fluorescent layer 31 is 75 degrees or larger and 84 degrees or smaller. It is therefore possible to prevent the second excitation light 88 from leaking outside the first fluorescent layer 31, and to selectively radiate the second excitation light 88 only toward the first fluorescent layer 31, by causing the collimated second excitation light 88 to be incident on the first fluorescent layer 31.

Like the first light source 91, the second light source 92 can selectively radiate the second excitation light 88 only toward the corresponding second fluorescent layer 32. Further, like the first light source 91, the third light source 93 can selectively irradiate the second excitation light 88 only toward the corresponding third fluorescent layer 33.

If there is a refractive index difference between the fluorescent layer and the separation layer, the first excitation light 20 can be reflected at the interface of these layers and create a loss. In the case the refractive index difference between the fluorescent layer and the separation layer is 0.01 or larger and 0.05 or smaller, however, the double-surface transmittance of the first excitation light 20 passing through both the interface for entering the fluorescent layer and the interface for exiting the fluorescent layer is 99.94% or higher. Even if the number of alternate laminates of the fluorescent layer and the separation layer is 1000, therefore, a transmittance of 588 or higher can be realized overall. In the case the refractive index difference between the fluorescent layer and the separation layer is 0.025, for example, the double-surface transmittance of the first excitation light 20 is 99.98% or higher, and the transmittance resulting when the number of alternate laminates is 1,000 is 87% or more. It is noted that the case where the number of alternate laminates of the fluorescent layer and the separation layer is 1,000 is the case where the total number of the first fluorescent layer 31, the second fluorescent layer 32, and the third fluorescent layer 33 is 1,000, and the total number of the first separation layer 34, the second separation layer 35, and the third separation layer 36 is 1,000. The control unit 18 controls the operation of the first irradiation unit 16 and the second irradiation unit 90. The control unit 18 acquires the stereoscopic contour image data and activates the first irradiation unit 16 and the second irradiation unit 90 based on the stereoscopic contour image data. The control unit 18 controls the operation of the lens drive mechanism 44 and the mirror drive mechanism 48 to cause the light collection position 24 of the first excitation light 20 to perform three-dimensional scan inside the display unit 12C. The control unit 18 activates the second irradiation unit 90 so that the second excitation light 88 selectively irradiates the fluorescent layer corresponding to the light collection position 24 of the first excitation light 20. The control unit 18 lights the first light source 91, the second light source 92, or the third light source 93 for radiating the second excitation light 88 toward the fluorescent layer corresponding to the light collection position 24 of the first excitation light 20. The control unit 18 controls the output intensity of the light source 40 according to the light collection position 24 of the first excitation light 20 to realize the display color designated by the stereoscopic contour image data for each drawing position. The control unit 18 may control the output intensity of the light emitting element 94 according to the light collection position 24 of the first excitation light 20 to realize the display color designated by the stereoscopic contour image data for each drawing position. This makes it possible to draw the stereoscopic image S corresponding to the stereoscopic contour image data inside the display unit 12.

According to this embodiment, ASE can be produced in a limited region 98 where the first excitation light 20 and the second excitation light 88 are superimposed, and ASE can be prevented from being produced outside the limited region 98. As a result, color bleeding and degradation in drawing contrast can be suppressed, and the accuracy of displaying the stereoscopic image S can be improved. For example, ASE is suitably prevented from being produced in the second fluorescent layer 32 and the third fluorescent layer 33 adjacent to the first fluorescent layer 31 even if the thickness t1 of the first fluorescent layer 31 is smaller than the Rayleigh length Zr of the first excitation light 20. In this embodiment, as in the fourth and fifth embodiments, ASE is suitably prevented from being produced in the fluorescent layer different from the light collection position 24 of the first excitation light 20 even if total thickness of the fluorescent layer and the separation layer is configured to be larger than the Rayleigh length Zr of the first excitation light 20 and smaller than twice the Rayleigh length Zr.

In this embodiment, the region 98 in which ASE is produced can be formed in a shape close to spherical by configuring the thickness of the fluorescent layer to be commensurate with the spot size w₀ at the light collection position 24 of the first excitation light 20. More specifically, the region 98 in which ASE is produced can be formed in a shape close to spherical by configuring the thickness of the fluorescent layer to be 0.5 times or more and 2 times or less larger than the spot size Wo of the first excitation light 20 at the light collection position 24. By forming the region 98 in which ASE is produced in a shape close to spherical, it is possible to draw a higher definition stereoscopic image S.

In a variation of the seventh embodiment, a plurality of second irradiation units 90 may be used. For example, the display apparatus according to the variation may include a plurality of second irradiation units that radiate the second excitation light toward the plurality of side surfaces of the display unit 12C. Each of the plurality of second irradiation units is configured to radiate the second excitation light toward the same fluorescent layer corresponding to the light collection position 24 of the first excitation light 20. According to this variation, it is possible to irradiate the entirety of the fluorescent layer to be irradiated in the in-plane direction with a more uniform second excitation light, by radiating the second excitation light from the plurality of side surfaces.

In a variation of the seventh embodiment, a reflective film reflecting the second excitation light 88 may be provided on at least one of the plurality of side surfaces of the display unit 12C. For example, a reflective film may not be provided on the first side surface that the second excitation light 88 from the second irradiation unit 90 is incident on, and a reflective film may be provided on the second side surface different from the first side surface. The reflective film may be configured to selectively reflect the wavelength of the second excitation light 88 and selectively transmit the emission wavelength of the fluorescent layer. By providing a reflective film on the side surface of the display unit 12C, the second excitation light 88 can be more efficiently radiated toward the fluorescent layer to be irradiated. It is also possible to irradiate the entirety of the fluorescent layer to be irradiated in the in-plane direction with a more uniform second excitation light.

In the seventh embodiment, the thickness t1, t2, t3 of the plurality of first fluorescent layers 31, the plurality of second fluorescent layers 32, and the plurality of third fluorescent layers 33, respectively, may differ in accordance with a change in the Rayleigh length Zr dependent on the light collection position 24 in the z direction. That is, the thickness t1, t2, and t3 of the plurality of first fluorescent layers 31, the plurality of second fluorescent layers 32, and the plurality of third fluorescent layers 33, respectively, may be configured to increase in a direction away from the first surface 13. Similarly, the thickness t4, t5, and t6 of the plurality of first separation layers 34, the plurality of second separation layers 35, and the plurality of third separation layers 36, respectively, may be configured to increase in a direction away from the first surface 13.

In the seventh embodiment, the irradiation unit 16A according to the second embodiment may be used. In this case, the thickness t1, t2, t3 of the plurality of first fluorescent layers 31, the plurality of second fluorescent layers 32, and the plurality of third fluorescent layers 33 may be constant, and the thickness t4, t5, t6 of the plurality of first separation layers 34, the plurality of second separation layers 35, and the plurality of third separation layers 36 may be constant.

In the seventh embodiment, the irradiation unit 16B according to the third embodiment may be used. In this case, the second irradiation unit 90 may simultaneously irradiate each of the first fluorescent layer 31, the second fluorescent layer 32, and the third fluorescent layer 33 corresponding to the first light collection position 25, the second light collection position 26, and the third light collection position 27, respectively, with the excitation light. For example, a fourth excitation light for exciting the first phosphor may be radiated from the first light source 91 toward the first fluorescent layer 31, a fifth excitation light for exciting the second phosphor may be radiated from the second light source 92 toward the second fluorescent layer 32, and a sixth excitation light for exciting the third phosphor may be radiated from the third light source 93 toward the third fluorescent layer 33. The fourth excitation light, the fifth excitation light, and the sixth excitation light may have the same emission wavelength, or the emission wavelength may be different from each other.

### Eighth Embodiment

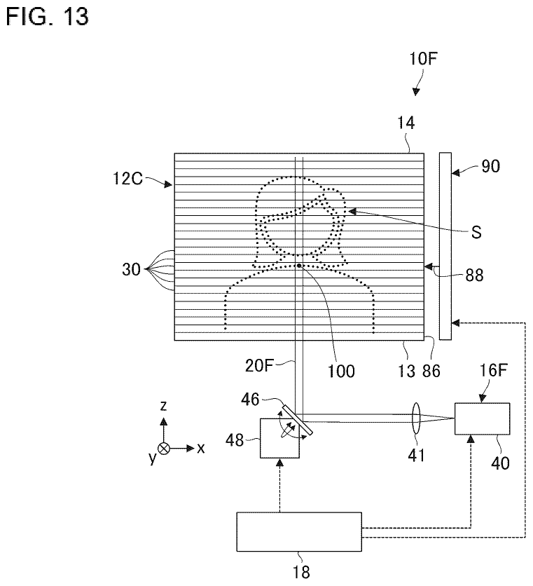

FIG. 13 is a diagram schematically showing the configuration of a display apparatus 10F according to the eighth embodiment. The irradiation unit 16F according to the eighth embodiment does not include the light collection lens 42 and the lens drive mechanism 44 and is configured to radiate a first excitation light 20F collimated by the collimating lens 41 toward the display unit 12C. The following description of the eighth embodiment highlights the difference from the seventh embodiment. A description of features common to those of the seventh embodiment is omitted as appropriate.

The display apparatus 10F includes a display unit 12, a first irradiation unit 16F, a second irradiation unit 90, and a control unit 18. The display apparatus 10F may or may not include an image sensor 50 and a light sensor 52. The display unit 12C, the second irradiation unit 90, and the control unit 18 are configured in the same manner as in the seventh embodiment.

The first irradiation unit 16F includes a light source 40, a collimating lens 41, a mirror 46, and a mirror drive mechanism 48. The first irradiation unit 16F does not include a light collection lens 42 and a lens drive mechanism 44. The mirror 46 reflects the first excitation light 20F parallelized by the collimating lens 41 toward the first surface 13 of the display unit 12C. The mirror drive mechanism 48 changes the position of the first excitation light 20F in the in-plane direction (x direction and y direction) by changing the orientation of the mirror 46.

In this embodiment, the light intensity of each of the first excitation light 20F and the second excitation light 88 is lower than the threshold value of the amplified spontaneous emission of the phosphor (i.e., lower than the ASE threshold value), and the total value of the light intensity of the first excitation light 20 and the second excitation light 88 is equal to or higher than the threshold value of the amplified spontaneous emission of the phosphor (i.e., equal to or higher than the ASE threshold value). Therefore, ASE is produced at an intersection 100 where the first excitation light 20F and the second excitation light 88 are superimposed, and ASE is not produced at a location different from the intersection 100.

The control unit 18 controls the operation of the first irradiation unit 16F and the second irradiation unit 90. The control unit 18 acquires the stereoscopic contour image data and activates the first irradiation unit 16F and the second irradiation unit 90 based on the stereoscopic contour image data. The control unit 18 controls the operation of the mirror drive mechanism 48 to change the position of the first excitation light 20F in the in-plane direction inside the display unit 12C. The control unit 18 controls the operation of the second irradiation unit 90 to change the position of the second excitation light 88 in the lamination direction. In this way, the control unit 18 controls the three-dimensional position at which the contour of the stereoscopic image S should be displayed. The control unit 18 may control the output intensity of at least one of the first excitation light 20F or the second excitation light 88 according to the position of the first excitation light 20F in the in-plane direction or the position of the second excitation light 88 in the lamination direction to realize the display color designated by the stereoscopic contour image data for each drawing position.

According to this embodiment, it is not necessary to control the light collection position 24 of the first excitation light 20 in three dimensions, and the irradiation direction of the excitation light 20F need be controlled only in two dimensions. It is therefore easy to control the three-dimensional position of the intersection 100 where ASE is produced.

### Ninth Embodiment

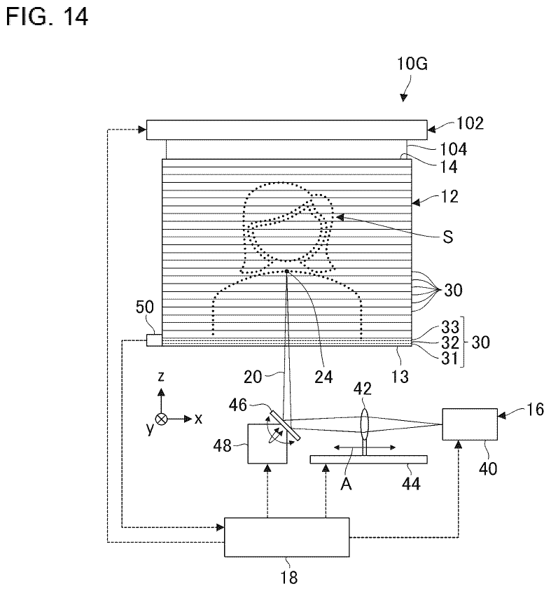

FIG. 14 is a diagram schematically showing the configuration of a display apparatus 10G according to the ninth embodiment. The ninth embodiment differs from the first embodiment described above in that a second irradiation unit 102 that radiates a second excitation light 104 toward the second surface 14 of the display unit 12 is provided in addition to the first irradiation unit 16 that radiates the first excitation light 20 toward the first surface 13 of the display unit 12. The following description of the ninth embodiment highlights the difference from the first embodiment. A description of features common to those of the first embodiment is omitted as appropriate.

The display apparatus 10G includes a display unit 12, a first irradiation unit 16, a second irradiation unit 102, and a control unit 18. The display apparatus 10G may or may not include an image sensor 50. The display unit 12, the first irradiation unit 16, and the control unit 18 are configured in the same manner as in the first embodiment.

The second irradiation unit 102 radiates the second excitation light 104 for exciting the phosphor toward the display unit 12. The second excitation light 104 is incident on the second surface 14 of the display unit 12 and irradiates the display unit 12 from the side opposite to that of the first excitation light 20. The second irradiation unit 102 is a surface-emitting light source configured to irradiate the entirety of the second surface 14 of the display unit 12 with the second excitation light 104. The second excitation light 104 may have the same wavelength as the first excitation light 20, and may be ultraviolet light having a center wavelength included in the range of 300 nm-400 nm.

The second excitation light 104 has the role of facilitating the excitation of the phosphor by the first excitation light 20. The intensity of the first excitation light 20 incident on the first surface 13 of the display unit 12 attenuates as it passes through the display unit 12. Further, in the case the light collection position 24 of the first excitation light 20 is changed according to the position of one light collection lens 42 as shown in FIG. 14, the spot diameter of the first excitation light 20 increases and the light collection intensity of the first excitation light 20 decreases as the light collection position 24 approaches the second surface 14. Given the constant output intensity of the light source 40, therefore, the light collection intensity of the first excitation light 20 becomes stronger as the light collection position 24 approaches the first surface and weaker as the light collection position 24 approaches the second surface 14. On the other hand, the light collection intensity of the second excitation light 104 becomes stronger as the light collection position approaches the second surface 14 and weaker as the light collection position approaches the first surface 13. By irradiating the display unit 12 with such the second excitation light 104, excitation at the light collection position 24 is facilitated, and variation in the total value of the light intensity of the first excitation light 20 and the second excitation light 104 at the light collection position 24 caused by a change in the light collection position 24 can be reduced.

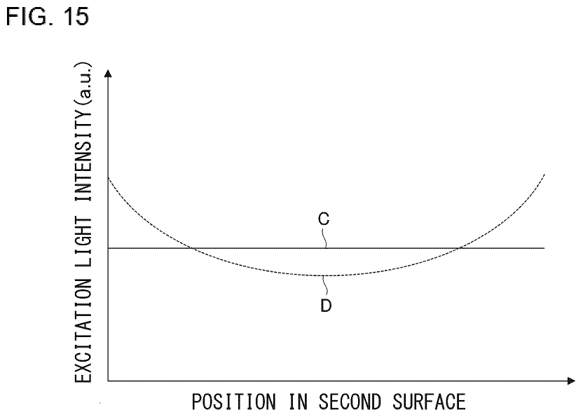

FIG. 15 is a graph schematically showing an example of the light intensity distribution of the second excitation light 104. As indicated by the solid line C in FIG. 15, the second irradiation unit 102 may radiate the second excitation light 104 having a uniform light intensity on the second surface 14. The second irradiation unit 102 may radiate the second excitation light 104 having an intensity distribution dependent on the position on the second surface 14. As indicated by the dashed line D in FIG. 2, the second irradiation unit 102 may radiate the second excitation light 104 having an intensity distribution in which the light intensity in the central portion of the second surface 14 is relatively low and the light intensity in the peripheral portion of the second surface 14 is relatively high. Since the central portion of the display unit 12 has a relatively short distance from the mirror 46 that reflects the first excitation light 20, the light collection intensity of the first excitation light 20 is larger than in the peripheral portion that is far from the mirror 46. On the other hand, the peripheral portion of the display unit 12 has a relatively long distance from the mirror 46 so that the light collection intensity of the first excitation light 20 is relatively small. By configuring the light intensity in the central portion of the second excitation light 104 to be low and configuring the light intensity in the peripheral portion of the second excitation light 104 to be high, therefore, variation in the total value of the light intensity of the first excitation light 20 and the second excitation light 104 at the light collection position 24 caused by a change in the position of the light collection position 24 can be reduced.

The light intensity of the second excitation light 104 is set so as not to exceed the threshold value of the amplified spontaneous emission (ASE) of the phosphor included in the display unit 12. On the other hand, the total value of the light intensity of the first excitation light 20 and the second excitation light 104 at the light collection position 24 is set to be equal to or higher than threshold value (ASE threshold value) of the amplified spontaneous emission of the phosphor.

The control unit 18 may change the light intensity of the second excitation light 104 according to the light collection position 24 of the first excitation light 20, by controlling the operation of the second irradiation unit 102. For example, the closer the light collection position 24 of the first excitation light 20 is to the second surface 14, i.e., the farther away from the first surface 13, the higher the light intensity of the second excitation light 104 may be. The total value of the light intensity of the first excitation light 20 and the second excitation light 22 at the light collection position 24 may be ensured to be equal to or higher than the ASE threshold in this way.

According to this embodiment, it is possible to prevent the entirety of display unit 12 from emitting light brightly by configuring the light intensity of the second excitation light 104 to be lower than the ASE threshold. By configuring the total value of the light intensity of the first excitation light 20 and the second excitation light 104 at the light collection position 24 to be equal to or higher than the ASE threshold, on the other hand, strong light emission by ASE can be obtained at the light collection position 24, and the contrast ratio with respect to light emission (background light) at a location different from the light collection position 24 can be increased.

The second irradiation unit 102 according to the ninth embodiment can be used in combination with any of the above-described embodiments. For example, the second irradiation unit 102 may be applied to the second embodiment of FIG. 4, the third embodiment of FIGS. 5-6, the fourth embodiment of FIGS. 7-8, or the fifth embodiment of FIG. 9.

### Tenth Embodiment

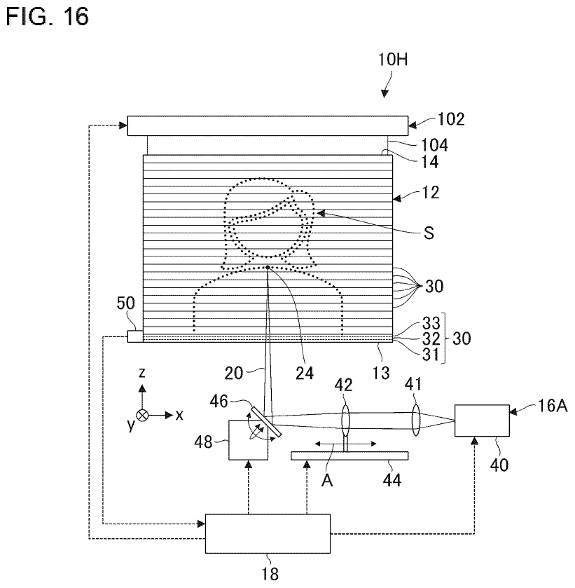

FIG. 16 is a diagram schematically showing the configuration of a display apparatus 10H according to the tenth embodiment. The tenth embodiment differs from the ninth embodiment described above in that the first irradiation unit 16A further includes a collimating lens 41 and is configured in the same manner as in the second embodiment. The following description of the tenth embodiment highlights the difference from the ninth embodiment. A description of features common to those of the ninth embodiment is omitted as appropriate.

The display apparatus 10H includes a display unit 12, a first irradiation unit 16, a second irradiation unit 102, and a control unit 18. The display apparatus 10G may or may not include an image sensor 50. The first irradiation unit 16A is configured in the same manner as in the second embodiment. The display unit 12, the second irradiation unit 102, and the control unit 18 are configured in the same manner as in the ninth embodiment.

According to this embodiment, it is possible, by using the collimating lens 41, to suppress a change in the spot diameter of the first excitation light 20 according to the light collection position 24 of the first excitation light 20. This makes it possible to reduce fluctuation in the light intensity of the first excitation light 20 at the light collection position 24 caused by a change in the light collection position 24. As a result, the proportion of facilitation by the second excitation light 104 can be reduced, and the rate of changing the light intensity of the second excitation light 104 according to the light collection position 24 can be reduced as compared to the ninth embodiment. By reducing the proportion of facilitation by the second excitation light 104, the intensity of light emission (background light) at a location different from the light collection position 24 can be reduced. Further, by reducing the rate of changing the light intensity of the second excitation light 104 according to the light collection position 24, variation in the intensity of the light emission (background light) at a location different from the light collection position 24 can be reduced.

### Eleventh Embodiment

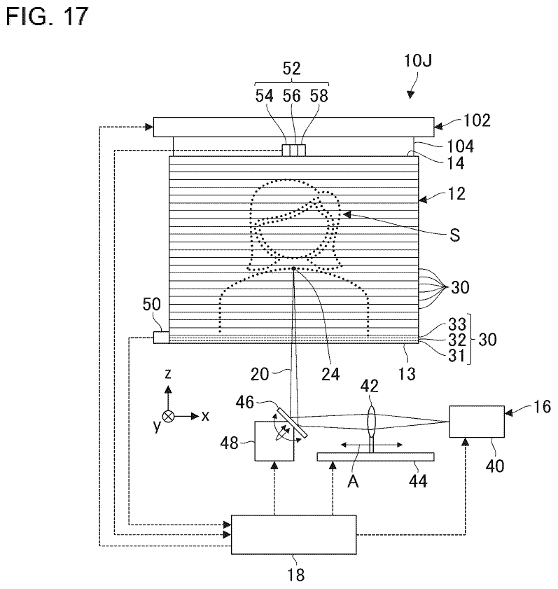

FIG. 17 is a diagram schematically showing the configuration of a display apparatus 10J according to the eleventh embodiment. The eleventh embodiment differs from the ninth embodiment described above in that the display apparatus 10J further includes a light sensor 52. The following description of the eleventh embodiment highlights the difference from the ninth embodiment. A description of features common to those of the ninth embodiment is omitted as appropriate.

The display apparatus 10B includes a display unit 12, a first irradiation unit 16, a second irradiation unit 102, a control unit 18, and a light sensor 52. The display apparatus 10J may or may not include an image sensor 50. The display unit 12, the first irradiation unit 16, the second irradiation unit 102, the control unit 18, and the image sensor 50 are configured in the same manner as in the ninth embodiment. The light sensor 52 is configured in the same manner as in the first embodiment.

According to this embodiment, the positional accuracy of drawing the stereoscopic image S can be improved, and the accuracy of displaying the stereoscopic image S can be improved, by calibrating the light collection position 24 of the first excitation light 20 based on the measurement result of the light sensor 52.

### Twelfth Embodiment

In the twelfth embodiment, a portion of the fluorescent layer included in the display unit contains an infrared phosphor having an emission wavelength in the infrared range. The infrared phosphor is excited by the first excitation light 20 and emits an infrared light. The light intensity of the infrared light produced from the infrared phosphor is detected by a light sensor and is used to determine which fluorescent layer the light collection position 24 of the first excitation light 20 is in.

A plurality of types of infrared phosphors having different emission wavelengths in the infrared region can be used as the infrared phosphor. For example, a first infrared phosphor having an emission wavelength of 800 nm, a second infrared phosphor having an emission wavelength of 900 nm, a third infrared phosphor having an emission wavelength of 1000 nm, a fourth infrared phosphor having an emission wavelength of 1100 nm, a fifth infrared phosphor having an emission wavelength of 1200 nm, and a sixth infrared phosphor having an emission wavelength of 1300 nm can be used. By configuring the types of infrared phosphors contained in the fluorescent layer to be different, it is possible to determine which fluorescent layer the light collection position 24 of the first excitation light 20 is in, based on the wavelength of infrared light detected by the light sensor.

The following description of the twelfth embodiment highlights the difference from the first embodiment. A description of features common to those of the first embodiment is omitted as appropriate. The display apparatus according to the twelfth embodiment has the same configuration as the display apparatus 10 according to the first embodiment but differs in the configuration of the display unit 12 and the light sensor 52.

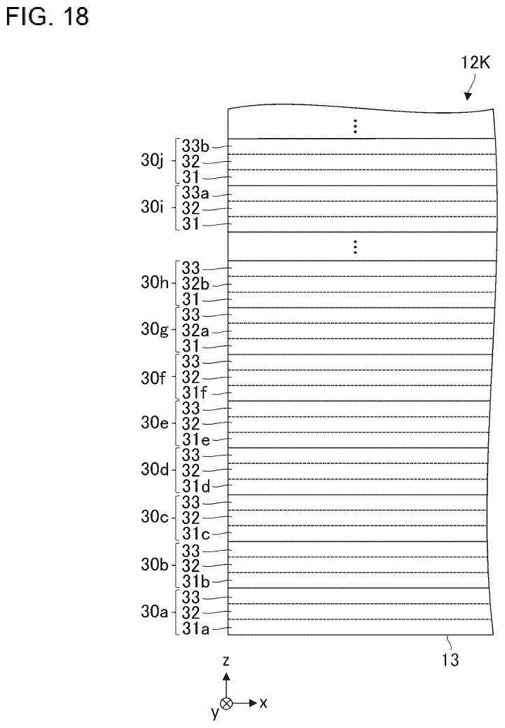

FIG. 18 is a diagram schematically showing the configuration of a display unit 12K according to the twelfth embodiment. The display unit 12K includes a plurality of laminated bodies 30a, 30b, 30c, 30d, 30e, 30f, 30g, 30h, 30i, and 30j laminated in the z direction.

The laminated bodies 30a-30f include first fluorescent layers 31a-31f containing the first phosphor and an infrared phosphor, a second fluorescent layer 32 containing the second phosphor and not containing an infrared phosphor, and a third fluorescent layer 33 containing the third phosphor and not containing an infrared phosphor. The first fluorescent layer 31a included in the first laminated body 30a contains the first phosphor and the first infrared phosphor (for example, having an emission wavelength of 800 nm). The first fluorescent layer 31b included in the second laminated body 30b contains the first phosphor and the second infrared phosphor (for example, having an emission wavelength of 900 nm). The first fluorescent layer 31c included in the third laminated body 30c contains the first phosphor and the third infrared phosphor (for example, having an emission wavelength of 1000 nm). The first fluorescent layer 31d included in the fourth laminated body 30d contains the first phosphor and the fourth infrared phosphor (for example, having an emission wavelength of 1100 nm). The first fluorescent layer 31e included in the fifth laminated body 30e contains the first phosphor and the fifth infrared phosphor (for example, having an emission wavelength of 1200 nm). The first fluorescent layer 31f included in the sixth laminated body 30f contains the first phosphor and the sixth infrared phosphor (for example, having an emission wavelength of 1300 nm).

The laminated bodies 30g and 30h include the first fluorescent layer 31 containing the first phosphor and not containing an infrared phosphor, second fluorescent layers 32a and 32b containing the second phosphor and an infrared phosphor, and the third fluorescent layer 33 containing the third phosphor and not containing an infrared phosphor. The second fluorescent layer 32a contained in the seventh laminated body 30g contains the second phosphor and the first infrared phosphor (for example, having an emission wavelength of 800 nm). The second fluorescent layer 32b included in the eighth laminated body 30h contains the second phosphor and the second infrared phosphor (for example, having an emission wavelength of 900 nm). The second fluorescent layer included in the laminated body not shown may contain the second phosphor and may contain any one of the third infrared phosphor, the fourth infrared phosphor, the fifth infrared phosphor, and the sixth infrared phosphor.

The laminated bodies 30i and 30j include the first fluorescent layer 31 containing the first phosphor and not containing an infrared phosphor, the second fluorescent layer 32 containing the second phosphor and not containing an infrared phosphor, and third fluorescent layer 33a and 33b containing the third phosphor and an infrared phosphor. The third fluorescent layer 33a included in the ninth laminated body 30i contains the third phosphor and the first infrared phosphor (for example, having an emission wavelength of 800 nm). The third fluorescent layer 33b included in the tenth laminated body 30j contains the third phosphor and the second infrared phosphor (for example, having an emission wavelength of 900 nm). The third fluorescent layer included in the laminated body not shown may contain the third phosphor and may contain any one of the third infrared phosphor, the fourth infrared phosphor, the fifth infrared phosphor, and the sixth infrared phosphor.

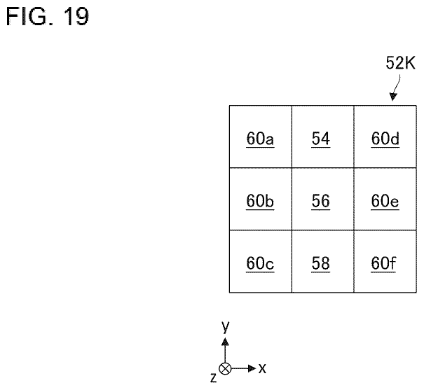

FIG. 19 is a diagram schematically showing the configuration of a light sensor 52K according to the twelfth embodiment. The light sensor 52K includes a plurality of sensors 54, 56, 58, 60a, 60b, 60c, 60d, 60e, and 60f with different detectable wavelengths. The first sensor 54, the second sensor 56, and the third sensor 58 are configured in the same manner as in the first embodiment and are, for example, configured to measure the light intensity in red, green, and blue.

The light sensor 52K includes a plurality of infrared sensors 60a-60f. The first infrared sensor 60a is configured to measure the light intensity at the emission wavelength of the first infrared phosphor, and has, for example, a filter that selectively transmits infrared light at 800 nm. The second infrared sensor 60b is configured to measure the light intensity at the emission wavelength of the second infrared phosphor, and has, for example, a filter that selectively transmits infrared light at 900 nm. The third infrared sensor 60c is configured to measure the light intensity at the emission wavelength of the third infrared phosphor, and has, for example, a filter that selectively transmits infrared light at 1000 nm. The fourth infrared sensor 60d is configured to measure the light intensity at the emission wavelength of the fourth infrared phosphor and has, for example, a filter that selectively transmits infrared light at 1100 nm. The fifth infrared sensor 60e is configured to measure the light intensity at the emission wavelength of the fifth infrared phosphor and has, for example, a filter that selectively transmits infrared light at 1200 nm. The sixth infrared sensor 60f is configured to measure the light intensity at the emission wavelength of the sixth infrared phosphor and has, for example, a filter that selectively transmits infrared light at 1300 nm.

The control unit 18 acquires the light intensity at each wavelength measured by the light sensor 52K, activating the lens drive mechanism 44 and changing the position of the light collection lens 42. The control unit 18 determines, based on the light intensity at each wavelength measured by the light sensor 52, which of the plurality of types of infrared phosphors that the fluorescent layer, where the light collection position 24 of the first excitation light 20 is located, has. For example, it can be determined that the light collection position 24 is in the first fluorescent layer 31a containing the first phosphor and the first infrared phosphor, when the light intensity at the emission wavelength (red) of the first phosphor is highest (or maximized) and the light intensity at the emission wavelength (800 nm) of the first infrared phosphor is highest (or maximized).

In the example of FIG. 18, a case where each of the continuous laminated bodies 30a-30h contains an infrared phosphor is shown. In a variation, a laminated body containing an infrared phosphor and a laminated body not containing an infrared phosphor may be alternately laminated. For example, a plurality of (for example, 9) laminated bodies 30 not containing an infrared phosphor may be laminated on the first laminated body 30a containing the first infrared phosphor, and the second laminated body 30b containing the second infrared phosphor may be laminated thereon. For example, a fluorescent layer containing an infrared phosphor used as a reference for positioning may be provided for each of 10 laminated bodies. This makes it possible to set a reference for positioning by providing an appropriate interval in the case the number of laminated bodies 30 of the display unit 12K is large.

In the example of FIG. 18, a case in which one type of infrared phosphor is contained in one fluorescent layer is shown. In a further variation, two or more types of infrared phosphors may be contained in one fluorescent layer. For example, one fluorescent layer may contain the first infrared phosphor and the second infrared phosphor or contain the first infrared phosphor, the second infrared phosphor, and the third infrared phosphor. Further, the combination of infrared phosphors to be contained may differ depending on the fluorescent layer used as a reference for positioning. By combining two or more types of infrared phosphors, the number of patterns for identifying the fluorescent layer can be increased using a limited number of types of infrared phosphors. Thereby, the position of the fluorescent layer can be identified in finer detail, and the accuracy of displaying the stereoscopic image S can be improved in the case the number of laminated bodies 30 of the display unit 12K is large.

The display unit 12K and the light sensor 52K according to the twelfth embodiment can be used in combination with any of the above-described embodiments. For example, the display unit 12K and the light sensor 52K according to the twelfth embodiment can be used instead of the display unit 12 and the light sensor 52 in any embodiment described above. Further, the position of the fluorescent layers 31-33 may be identified in finer detail by containing an infrared phosphor in the fluorescent layers 31-33 included in the display unit 12C shown in FIG. 7-9.

### Thirteenth Embodiment

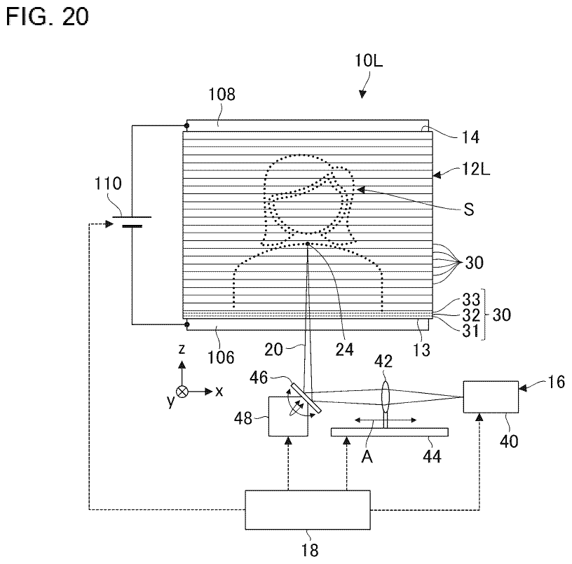

FIG. 20 is a diagram schematically showing the configuration of a display apparatus 10L according to the thirteenth embodiment. The thirteenth embodiment differs from the first embodiment described above in that it includes a power supply 110 that applies a voltage between the first surface 13 and the second surface 14 of the display unit 12L. The following description of the thirteenth embodiment highlights the difference from the first embodiment. A description of features common to those of the first embodiment is omitted as appropriate.

The display apparatus 10L includes a display unit 12L, an irradiation unit 16, a control unit 18, a first electrode 106, a second electrode 108, and a power supply 110. The first irradiation unit 16 and the control unit 18 are configured in the same manner as in the first embodiment.

The display unit 12L is configured in the same manner as the display unit 12 according to the first embodiment but differs from the first embodiment in that it has conductivity. Each of the first fluorescent layer 31, the second fluorescent layer 32, and the third fluorescent layer 33 included in the plurality of laminated bodies 30 of the display unit 12L is configured to have conductivity. For example, the fluorescent layer is configured to have conductivity by using a conductive polymer such as polyacetylene and polythiophene as the base material of the first fluorescent layer 31, the second fluorescent layer 32, and the third fluorescent layer 33. Alternatively, conductivity may be imparted by causing the first fluorescent layer 31, the second fluorescent layer 32, and the third fluorescent layer 33 to contain conductive particles.

The first electrode 106 is provided on the first surface 13 of the display unit 12L. The first electrode 106 is a transparent electrode that transmits the first excitation light 20 and is made of a conductive oxide material such as indium tin oxide (ITO). The second electrode 108 is provided on the second surface 14 of the display unit 12L. The second electrode 108 is preferably a transparent electrode like the first electrode 106 but may not be a transparent electrode.

The power supply 110 applies a voltage between the first electrode 106 and the second electrode 108. The power supply 110 electrically excites the phosphor contained in the display unit 12L by applying a voltage to the display unit 12L. The power supply 110 applies an auxiliary voltage to the entirety of the display unit 12L and supplementarily excites the phosphor contained in the display unit 12L. In the case the phosphor is electrically excited, the amount of light emitted by the phosphor depends on the current density, and the higher the current density, the larger the amount of light emitted. The power supply 110 controls the current flowing between the first electrode 106 and the second electrode 108 so that the current density is such that the phosphor does not produce ASE in a state where the first excitation light 20 is not radiated. That is, the density of the current flowing between the first electrode 106 and the second electrode 108 is controlled to be lower than the “threshold current density of the amplified spontaneous emission”, which is the current density necessary to produce ASE. The power supply 110 may have a constant current circuit.

The first irradiation unit 16 radiates the first excitation light 20 having a light intensity at which the phosphor can produce ASE at the light collection position 24 of the first excitation light 20 in a state where an auxiliary voltage is applied by the power supply 110. The first irradiation unit 16 causes the phosphor to produce ASE at the light collection position 24 according to the sum of the contribution by the first excitation light 20 and the contribution of electrical excitation by the power supply 110 at the light collection position 24.

The control unit 18 may change the current density of the current flowing through the display unit 12L according to the light collection position 24 of the first excitation light 20, by controlling the operation of the power supply 110. For example, the closer the light collection position 24 of the first excitation light 20 is to the second surface 14, i.e., the farther away from the first surface 13, the larger the amount of the current (or current density) flowing through the display unit 12L may be. It may be ensured in this way that the phosphor produces ASE at the light collection position 24 while, at the same time, suppressing variation in the sum of the contribution of the first excitation light 20 and the contribution of electrical excitation by the power supply 110 at the light collection position 24.

The power supply 110 according to the thirteenth embodiment can be used in combination with any of the above-described embodiments. For example, the power supply 110 may be applied to the second embodiment of FIG. 4, the third embodiment of FIGS. 5-6, the fourth embodiment of FIGS. 7-8, or the fifth embodiment of FIG. 9. When the power supply 110 is combined, the display unit 12C shown in FIGS. 7-9 is configured to have conductivity. The fluorescent layers 31-33 and the separation layers 34-36 constituting the display unit 12C are configured to have conductivity by using a conductive polymer such as polyacetylene or polythiophene as the base material.

### Fourteenth Embodiment

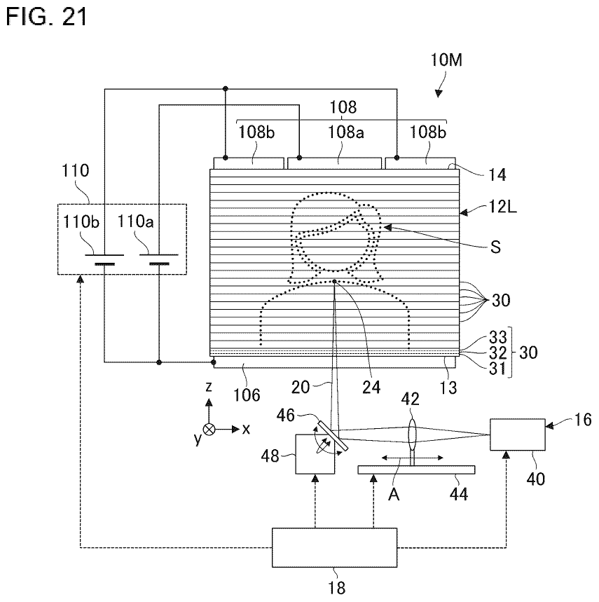

FIG. 21 is a diagram schematically showing the configuration of a display apparatus 10M according to the fourteenth embodiment. The fourteenth embodiment differs from the thirteenth embodiment described above in that separate power supplies 110a and 110b are connected to the central portion and the peripheral portion of the display unit 12L. The following description of the fourteenth embodiment highlights the difference from the thirteenth embodiment. A description of features common to those of the thirteenth embodiment is omitted as appropriate.

The display apparatus 10M includes a display unit 12L, a first irradiation unit 16, a control unit 18, a first electrode 106, a second electrode 108, and a power supply 110. The display unit 12L, the first irradiation unit 16, and the control unit 18 are configured in the same manner as in the thirteenth embodiment.

The second electrode 108 includes a central electrode 108a provided in the central portion of the second surface 14 of the display unit 12 and a peripheral electrode 108b provided in the peripheral portion of the second surface 14. The power supply 110 includes a first power supply 110a connected between the first electrode 106 and the central electrode 108a, and a second power supply 110b connected between the first electrode 106 and the peripheral electrode 108b.

The first power supply 110a is configured to induce a current having the first current density in the central portion of the display unit 12L. The second power supply 110b is configured to induce a current having the second current density larger than the first current density in the peripheral portion of the display unit 12L. Since the peripheral portion of the display unit 12L has a relatively long distance from the mirror 46, the light collection intensity of the first excitation light 20 is relatively small compared to the central portion of the display unit 12L. Therefore, variation in the sum of the contribution of the first excitation light 20 and the contribution of electrical excitation at the light collection position 24 caused by a change in the position of the light collection position 24 can be reduced by configuring the current density in the central portion of the display unit 12L to be relatively low and the current density in the peripheral portion of the display unit 12L to be relatively high.

In the example of FIG. 21, a case where two electrodes 108a and 108b are provided on the second surface 14 is shown. In a further variation, three or more electrodes set in a concentric circle pattern on the second surface 14 may be provided, and separate power supplies may be connected to the three or more electrodes, respectively. In this case, a voltage may be applied so that the current density in the central portion of the display unit 12L is small and the current density in the peripheral portion of the display unit 12L is large.

The power supply 110 according to the fourteenth embodiment can be used in combination with any of the above-described embodiments. For example, the power supply 110 may be applied to the second embodiment of FIG. 4, the third embodiment of FIGS. 5-6, the fourth embodiment of FIGS. 7-8, or the fifth embodiment of FIG. 9. When the power supply 110 is combined, the display unit 12C shown in FIGS. 7-9 is configured to have conductivity. The fluorescent layers 31-33 and the separation layers 34-36 constituting the display unit 12C are configured to have conductivity by using a conductive polymer such as polyacetylene or polythiophene as the base material.

The present disclosure has been explained with reference to the embodiments described above, but the present disclosure is not limited to the embodiments described above, and appropriate combinations or replacements of the features shown in the examples presented are also encompassed by the present disclosure.

Some embodiments of the present disclosure will be described.

### Embodiment 1

A display apparatus including:
a display unit in which a plurality of fluorescent layers containing a phosphor are laminated in a direction from a first surface to a second surface, the display unit being configured such that a thickness of each of the plurality of fluorescent layers increases in a direction away from the first surface; and
an irradiation unit that radiates an excitation light incident on the first surface of the display unit to excite the phosphor, changing a light collection position of the excitation light in the display unit.

### Embodiment 2

The display apparatus according to embodiment 1,
wherein the thickness of each of the plurality of fluorescent layers is twice or more larger than a Rayleigh length of the excitation light that results when the light collection position of the excitation light coincides with each of the plurality of fluorescent layers.

### Embodiment 3

The display apparatus according to embodiment 1 or 2,
wherein a light intensity of the excitation light at the light collection position is lower than a threshold value of amplified spontaneous emission of the phosphor.

### Embodiment 4

The display apparatus according to any one of embodiments 1 to 3,
wherein the display unit further includes a plurality of separation layers laminated to alternate with the plurality of fluorescent layers and not containing a phosphor.

### Embodiment 5

The display apparatus according to embodiment 4,
wherein the display apparatus is configured such that a thickness of each of the plurality of separation layers increases in a direction away from the first surface.

### Embodiment 6

A display apparatus including:
a display unit in which a plurality of first fluorescent layers containing a first phosphor and a plurality of second fluorescent layers containing a second phosphor having an emission wavelength different from the first phosphor are alternately laminated; and
an irradiation unit that superimposes a first excitation light incident on the display unit to excite the first phosphor and a second excitation light incident on the display unit to excite the second phosphor and that radiates the first excitation light and the second excitation light, changing a first light collection position of the first excitation light and a second light collection position of the second excitation light in the display unit.

### Embodiment 7

The display apparatus according to embodiment 6,
wherein a distance between the first light collection position and the second light collection position in the display unit is equal to a thickness of the first fluorescent layer or the second fluorescent layer.

### Embodiment 8

The display apparatus according to embodiment 6,
wherein a distance between the first light collection position and the second light collection position in the display unit is equal to half a sum of a thickness of the first fluorescent layer and a thickness of the second fluorescent layer.

### Embodiment 9

The display apparatus according to any one of embodiments 6 to 8,
wherein a thickness of each of the plurality of first fluorescent layers is twice or more larger than a Rayleigh length of the first excitation light, and
wherein a thickness of each of the plurality of second fluorescent layers is twice or more larger than a Rayleigh length of the second excitation light.

### Embodiment 10

The display apparatus according to any one of embodiments 6 to 9,
wherein a light intensity of the first excitation light at the first light collection position is 1.3 times or more and 1.5 times or less higher than a threshold value of amplified spontaneous emission of the first phosphor, and
wherein a light intensity of the second excitation light at the second light collection position is 1.3 times or more and 1.5 times or less higher than the threshold value of amplified spontaneous emission of the second phosphor.

### Embodiment 11

A display apparatus including:
a display unit in which a plurality of laminated bodies are laminated in a direction from a first surface to a second surface, each of the plurality of laminated bodies including a fluorescent layer containing a phosphor and a separation layer not containing a phosphor; and
an irradiation unit that radiates an excitation light incident on the display unit to excite the phosphor, changing a light collection position of the excitation light in the display unit.

### Embodiment 12

The display apparatus according to embodiment 11,
wherein a sum of half of a thickness of the fluorescent layer and a thickness of the separation layer in each of the plurality of laminated bodies is equal to or larger than a Rayleigh length of the excitation light that results when the light collection position of the excitation light coincides with each of the plurality of laminated bodies.

### Embodiment 13

The display apparatus according to embodiment 11 or 12,
wherein a sum of a thickness of the fluorescent layer and a thickness of the separation layer included in each of the plurality of laminated bodies is larger than a a Rayleigh length of the excitation light that results when the light collection position of the excitation light coincides with each of the plurality of laminated bodies and smaller than twice the Rayleigh length.

### Embodiment 14

The display apparatus according to any one of embodiments 11 to 13,
wherein a light intensity of the excitation light at the light collection position is 1.3 times or more and 1.5 times or less higher than a threshold value of amplified spontaneous emission of the phosphor.

### Embodiment 15

The display apparatus according to any one of embodiments 11 to 14,
wherein a thickness of the separation layer included in each of the plurality of laminated bodies increases in a direction away from the first surface.

### Embodiment 16

A display apparatus including:
a display unit in which a plurality of laminated bodies are laminated, each of the laminated bodies having a structure in which a first fluorescent layer containing a first phosphor, a first separation layer not containing a phosphor, a second fluorescent layer containing a second phosphor having an emission wavelength different from the first phosphor, and a second separation layer not containing a phosphor are laminated sequentially; and
an irradiation unit that superimposes a first excitation light incident on the display unit to excite the first phosphor and a second excitation light incident on the display unit to excite the second phosphor and that radiates the first excitation light and the second excitation light, changing a first light collection position of the first excitation light and a second light collection position of the second excitation light in the display unit.

### Embodiment 17

The display apparatus according to embodiment 16,
wherein a distance between the first light collection position and the second light collection position in the display unit is equal to or larger than a sum of half of a thickness of the second fluorescent layer and a Rayleigh length of the first excitation light or a sum of half of a thickness of the first fluorescent layer and a Rayleigh length of the second excitation light.

### Embodiment 18

The display apparatus according to embodiment 16 or 17,
wherein a distance between the first light collection position and the second light collection position in the display unit is equal to a sum of half of a thickness of the first fluorescent layer, a thickness of the first separation layer, and a half of a thickness of the second fluorescent layer.

### Embodiment 19

The display apparatus according to any one of embodiments 16 to 18,
wherein a distance between the first light collection position and the second light collection position in the display unit is larger than a Rayleigh length of the first excitation light or the second excitation light and smaller than twice the Rayleigh length.

### Embodiment 20

The display apparatus according to any one of embodiments 16 to 19,
wherein a light intensity of the first excitation light at the first light collection position is 1.3 times or more and 1.5 times or less higher than a threshold value of amplified spontaneous emission of the first phosphor, and
wherein a light intensity of the second excitation light at the second light collection position is 1.3 times or more and 1.5 times or less higher than the threshold value of amplified spontaneous emission of the second phosphor.

### Embodiment 21

A display apparatus including:
a display unit in which a plurality of fluorescent layers containing a phosphor and a plurality of separation layers not containing a phosphor are alternately laminated;
a first irradiation unit that radiates a first excitation light incident on the display unit in a lamination direction to excite the phosphor, changing a position of the first excitation light in an in-plane direction; and
a second irradiation unit that radiates a second excitation light incident on the plurality of fluorescent layers in the in-plane direction to excite the phosphor, changing a position of the second excitation light in the lamination direction.

### Embodiment 22

The display apparatus according to embodiment 21,
wherein a refractive index of the plurality of separation layers is lower than a refractive index of the plurality of fluorescent layers.

### Embodiment 23

The display apparatus according to embodiment 22,
wherein a difference between the refractive index of the plurality of separation layers and the refractive index of the plurality of fluorescent layers is 0.01 or larger and 0.05 or smaller.

### Embodiment 24

The display apparatus according to any one of embodiments 21 to 23,
wherein a light intensity of each of the first excitation light and the second excitation light is lower than a threshold value of amplified spontaneous emission of the phosphor, and
wherein a total value of the light intensity of the first excitation light and the second excitation light is equal to or higher than the threshold value of amplified spontaneous emission of the phosphor.

### Embodiment 25

The display apparatus according to any one of embodiments 21 to 24,
wherein a sum of a thickness of each of the plurality of fluorescent layers and a thickness of each of the plurality of separation layers is larger than a Rayleigh length of the first excitation light and smaller than twice the Rayleigh length.

### Embodiment 26

The display apparatus according to any one of embodiments 21 to 25,
wherein a thickness of each of the plurality of fluorescent layers is 0.5 times or more and 2 times or less larger than a spot size of the first excitation light at a light collection position.

### Embodiment 27

A display apparatus including:
a display unit in which a plurality of fluorescent layers containing a phosphor are laminated in a direction from a first surface to a second surface; and
a first irradiation unit that radiates a first excitation light incident on the first surface to excite the phosphor, changing a light collection position of the first excitation light in the display unit; and
a second irradiation unit that radiates a second excitation light incident on the second surface to excite the phosphor,
wherein a light intensity of the second excitation light is lower than a threshold value of amplified spontaneous emission of the phosphor, and
wherein a total value of a light intensity of the first excitation light and the second excitation light is equal to or higher than the threshold value of amplified spontaneous emission of the phosphor.

### Embodiment 28

The display apparatus according to embodiment 27,
wherein the second irradiation unit changes the light intensity of the second excitation light in accordance with the light collection position of the first excitation light.

### Embodiment 29

The display apparatus according to embodiment 27 or 28,
wherein the second irradiation unit irradiates an entirety of the second surface with the second excitation light.

### Embodiment 30

The display apparatus according to embodiment 29,
wherein the second irradiation unit radiates the second excitation light having an intensity distribution in which the light intensity in a peripheral portion of the second surface is higher than in a central portion of the second surface.

### Embodiment 31

A display method including:
radiating a first excitation light incident on a first surface of a display unit, in which a plurality of fluorescent layers containing a phosphor are laminated in a direction from the first surface to a second surface, changing a light collection position of the excitation light in the display unit; and
radiating a second excitation light incident on the second surface to excite the phosphor,
wherein a light intensity of the second excitation light is lower than a threshold value of amplified spontaneous emission of the phosphor, and
wherein a total value of a light intensity of the first excitation light and the second excitation light is equal to or higher than the threshold value of amplified spontaneous emission of the phosphor.

### Embodiment 32

A display apparatus including:
a display unit in which a plurality of first fluorescent layers containing a first phosphor and a plurality of second fluorescent layers containing a second phosphor having an emission wavelength different from the first phosphor are laminated;
an irradiation unit that radiates an excitation light incident on the display unit to excite the first phosphor and the second phosphor, changing a light collection position of the excitation light in the display unit;
a light sensor that measures a light intensity of a light emitted from the display unit at each wavelength; and
a control unit that controls the light collection position of the excitation light based on at least one of the light intensity at an emission wavelength of the first phosphor or the light intensity at an emission wavelength of the second phosphor measured by the light sensor.

### Embodiment 33

The display apparatus according to embodiment 32,
wherein the display unit includes a fluorescent layer containing an infrared phosphor having an emission wavelength in an infrared range, and
wherein the control unit controls the light collection position of the excitation light based further on the light intensity at an emission wavelength of the infrared phosphor measured by the light sensor.

### Embodiment 34

The display apparatus according to embodiment 33,
wherein the display unit includes a phosphor layer containing a first infrared phosphor having an emission wavelength in an infrared range and a phosphor layer containing a second infrared phosphor having an emission wavelength in an infrared range different from the first infrared phosphor, and
wherein the control unit controls the light collection position of the excitation light based further on the light intensity at an emission wavelength of the first infrared phosphor and the light intensity at an emission wavelength of the second infrared phosphor measured by the light sensor.

### Embodiment 35

The display apparatus according to embodiment 33 or 34,
wherein the display unit includes a fluorescent layer containing two or more of a plurality of types of infrared phosphors having mutually different emission wavelengths in the infrared range, and
wherein the control unit controls the light collection position of the excitation light based further on the light intensity at an emission wavelength of each of the plurality of types of infrared phosphors measured by the light sensor.

### Embodiment 36

A display method including:
radiating an excitation light incident on a display unit, in which a plurality of first fluorescent layers containing a first phosphor and a plurality of second fluorescent layers containing a second phosphor having an emission wavelength different from the first phosphor are laminated, to excite the first phosphor and the second phosphor, changing a light collection position of the excitation light in the display unit;
measuring an intensity of a light emitted from the display unit at each wavelength; and
controlling the light collection position of the excitation light based on at least one of the light intensity at an emission wavelength of the first phosphor or the light intensity at an emission wavelength of the second phosphor measured by the light sensor.

### Embodiment 37

A display apparatus including:
a display unit in which a plurality of fluorescent layers containing a phosphor are laminated in a direction from a first surface to a second surface;
a first electrode provided on the first surface;
a second electrode provided on the second surface;
a power supply that applies a voltage between the first electrode and the second electrode; and
an irradiation unit that radiates an excitation light incident on the display unit to excite the phosphor, changing a light collection position of the excitation light in the display unit.

### Embodiment 38

The display apparatus according to embodiment 37,
wherein the power supply changes an amount of a current flowing between the first electrode and the second electrode in accordance with the light collection position of the excitation light.

### Embodiment 39

The display apparatus according to embodiment 37 or 38,
wherein the power supply is configured to induce, between the first electrode and the second electrode, a current having a current density lower than a threshold current density of amplified spontaneous emission at which density the phosphor is adapted to produce amplified spontaneous emission, and
the irradiation unit radiates the excitation light having a light intensity at which the phosphor is adapted to produce amplified spontaneous emission.

### Embodiment 40

The display apparatus according to any one of embodiments 37 to 39,
wherein the second electrode includes a central electrode provided in a central portion of the second surface and a peripheral electrode provided in a peripheral portion of the second surface, and
the power supply includes a first power supply for inducing a current having a first current density between the first electrode and the central electrode and a second power supply for inducing a current having a second current density larger than first current density between the first electrode and the peripheral electrode.

### Embodiment 41

A display method including:
applying a dc voltage between a first electrode provided on a first surface of a display unit, in which a plurality of fluorescent layers containing a phosphor are laminated in a direction from the first surface to a second surface, and a second electrode provided on the second surface; and
radiating an excitation light incident on the display unit to excite the phosphor, changing a light collection position of the excitation light in the display unit.

What is claimed is:

1. A display apparatus comprising:
a display unit in which a plurality of fluorescent layers containing a phosphor are laminated in a direction from a first surface to a second surface; and
an irradiation unit that radiates an excitation light incident on the display unit to excite the phosphor, changing a position of the excitation light in an in-plane direction.

2. The display apparatus according to claim 1,
wherein the display unit is configured such that a thickness of each of the plurality of fluorescent layers increases in a direction away from the first surface, and
wherein the irradiation unit radiates the excitation light incident on the first surface of the display unit, changing a light collection position of the excitation light in the display unit.

3. The display apparatus according to claim 1,
wherein the plurality of fluorescent layers include a plurality of first fluorescent layers containing a first phosphor and a plurality of second fluorescent layers containing a second phosphor having an emission wavelength different from the first phosphor, and the plurality of first fluorescent layers and the plurality of second fluorescent layers are alternately laminated,
wherein the excitation light includes a first excitation light incident on the display unit to excite the first phosphor and a second excitation light incident on the display unit to excite the second phosphor, and
wherein the irradiation unit superimposes the first excitation light and the second excitation light and radiates the first excitation light and the second excitation light, changing a first light collection position of the first excitation light and a second light collection position of the second excitation light in the display unit.

4. The display apparatus according to claim 1,
wherein the display unit includes a plurality of laminated bodies laminated in a direction from the first surface to the second surface, and each of the plurality of laminated bodies includes a fluorescent layer, which is one of the plurality of fluorescent layers, and a separation layer not containing a phosphor, and
wherein the irradiation unit radiates the excitation light incident on the display unit, changing a light collection position of the excitation light in the display unit.

5. The display apparatus according to claim 1,
wherein the display unit includes a plurality of laminated bodies laminated in a direction from the first surface to the second surface, and each of the laminated bodies has a structure in which a first fluorescent layer, which is one of the plurality of fluorescent layers, containing a first phosphor, a first separation layer not containing a phosphor, a second fluorescent layer containing a second phosphor having an emission wavelength different from the first phosphor, and a second separation layer not containing a phosphor are laminated sequentially,
wherein the excitation light includes a first excitation light incident on the display unit to excite the first phosphor and a second excitation light incident on the display unit to excite the second phosphor, and
wherein the irradiation unit superimposes the first excitation light and the second excitation light and radiates the first excitation light and the second excitation light, changing a first light collection position of the first excitation light and a second light collection position of the second excitation light in the display unit.

6. The display apparatus according to claim 1,
wherein the display unit further includes a plurality of separation layers not containing a phosphor, and the plurality of fluorescent layers and the plurality of separation layers are alternately laminated,
wherein the irradiation unit is a first irradiation unit that radiates a first excitation light incident on the display unit in a lamination direction to excite the phosphor, changing a position of the first excitation light in an in-plane direction, the irradiation unit further including a second irradiation unit that radiates a second excitation light incident on the plurality of fluorescent layers in the in-plane direction to excite the phosphor, changing a position of the second excitation light in the lamination direction, is further included.

7. The display apparatus according to claim 1,
wherein the irradiation unit is a first irradiation unit that radiates a first excitation light incident on the first surface to excite the phosphor, changing a light collection position of the first excitation light in the display unit, the irradiation unit further including a second irradiation unit that radiates a second excitation light incident on the second surface to excite the phosphor is further included,
wherein a light intensity of the second excitation light is lower than a threshold value of amplified spontaneous emission of the phosphor, and
wherein a total value of the light intensity of the first excitation light and the second excitation light is equal to or higher than the threshold value of amplified spontaneous emission of the phosphor.

8. The display apparatus according to claim 1,
wherein the plurality of fluorescent layers include a plurality of first fluorescent layers containing a first phosphor and a plurality of second fluorescent layers containing a second phosphor having an emission wavelength different from the first phosphor, and the plurality of first fluorescent layers and the plurality of second fluorescent layers are alternately laminated, and
wherein the irradiation unit radiates the excitation light that excites the first phosphor and the second phosphor, changing a light collection position of the excitation light in the display unit,
the display apparatus further comprising:
a light sensor that measures a light intensity of a light emitted from the display unit at each wavelength; and
a control unit that controls the light collection position of the excitation light based on at least one of the light intensity at an emission wavelength of the first phosphor or the light intensity at an emission wavelength of the second phosphor measured by the light sensor.

9. The display apparatus according to claim 1, further comprising:
a first electrode provided on the first surface;
a second electrode provided on the second surface; and
a power supply that applies a voltage between the first electrode and the second electrode.
